(19) United States
(12) Patent Application Publication
(10) Pub. No.: US 2010/0067932 A1
(43) Pub. Date: Mar. 18, 2010

(54) IMAGE FORMING APPARATUS

(75) Inventor: Motohiro Fujiwara, Toride-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/558,377

(22) Filed: Sep. 11, 2009

(30) Foreign Application Priority Data
Sep. 12, 2008 (JP) 2008-235010

(51) Int. Cl. G03G 15/06

(52) U.S. Cl. 399/55

(57) ABSTRACT

An image forming apparatus includes an image carrier; an exposure unit configured to form an electrostatic latent image on the image carrier; a developing unit including a toner containing unit configured to accommodate a predetermined amount of toner, a toner supply unit configured to supply replenishment toner into the toner containing unit, a stirring unit configured to stir the toner to impart electric charge to the toner, a toner carrying member configured to carry the toner charged by the stirring unit, and a bias applying unit configured to apply a developing bias to the toner carrying member to develop the electrostatic latent image formed on the image carrier with the toner carried by the toner carrying member; a density sensor configured to detect a density of a toner pattern developed by the developing unit; and a control unit configured to control an amount of the toner supplied to the toner containing unit.

### BACKGROUND OF THE INVENTION

1. Field of the Invention

The present invention relates to an electrophotographic image forming apparatus such as a copying machine or a printer. More specifically, the present invention relates to an image forming apparatus that has a toner replenishment control function for controlling the amount of toner in a developing unit or controlling the density of an image.

2. Description of the Related Art

Conventionally, electrophotographic image forming apparatuses can form an electrostatic latent image on a photosensitive member and develop the latent image with toner to visualize it as a toner image. Various methods are available for stabilizing the density of an output image in such an electrophotographic image forming apparatus.

For example, as a method for stabilizing the density of an image output by an image forming apparatus that uses a two-component developer including toner particles (T) and carrier particles (C), it may be useful to stabilize the toner density in a developing unit as discussed in Japanese Patent Application Laid-Open No. 6-11965.

The toner density in a developing unit, which can be defined by a mixing ratio T/(T+C), i.e., a ratio of the weight of the toner particles to the total weight of the toner particles and the carrier particles, greatly influences the density of an image. Therefore, to stabilize the quality of an image, it is desired that the toner density in the developing unit has a value in a predetermined range. For example, to maintain the toner density at a constant level, the image forming apparatus using the two-component developer can replenish new toner to the developer.

The image forming apparatus discussed in Japanese Patent Application Laid-Open No. 6-11965 is equipped with a toner density detection/control device that can control the toner density to be a constant value. According to the image forming apparatus discussed in the above-described Japanese Patent Application Laid-Open No. 6-11965, a toner patch is formed on an image carrier (e.g., a photosensitive member or an intermediate transfer member).

If the density of the toner patch is higher than a predetermined density, the toner density detection/control device determines that the toner density is high and reduces the amount of the toner to be replenished. If the density of the toner patch is lower than the predetermined density, the toner density detection/control device determines that the toner density is low and increases the amount of the toner to be replenished. The above-described toner density control can be referred to as “patch detection auto toner replenishment (i.e., ATR).”

However, if the above-described toner density control based on the patch detection ATR is performed in a state where the toner charge amount is less than a desired charge amount, a toner patch having a density higher than the predetermined density may be formed. In such a case, the toner density detection/control device performs control for reducing the amount of toner supplied to the developing unit. Therefore, the toner density decreases and, as a result, the density of an output image decreases.

For example, the toner charge amount is lower than the desired value immediately after a power source of the image forming apparatus is turned on as understood from FIGS. 16A to 16D. FIG. 16A illustrates a temporal change in the toner charge amount. FIG. 16B illustrates a temporal change in development contrast for forming a toner patch. FIG. 16C illustrates a temporal change in patch density. FIG. 16D illustrates a temporal change in the toner density of the developing unit.

In FIGS. 16A to 16D, the power source of the image forming apparatus is in an ON state between point A and point Band after point C, during which the toner particles are stirred in the developing unit. On the other hand, the power source of the image forming apparatus is in an OFF state between point B and point C, during which the toner particles are not stirred in the developing unit. Electric charge cannot be imparted to the toner particles unless the toner particles are stirred in the developing unit. Therefore, as illustrated in FIG. 16A, the toner charge amount decreases continuously in the power-off period between point B and point C.

In FIGS. 16A to 16D, it can be believed that controlled values in the initial power-on period between point A and point B are ideal values for various controls to be performed by the apparatus to output an appropriate image. Therefore, if the power source is once tuned off, the apparatus resumes control for restoring respective values before turning off the power source (i.e., the above-described ideal values). More specifically, in FIGS. 16A to 16D, respective values in the power-on period between point A and point B can be set as control target values.

The above-described development contrast illustrated in FIG. 16B can be defined as a potential difference between the electric potential of an electrostatic latent image on a photosensitive member, which can be formed with laser light, and the DC voltage applied to a developing sleeve. If the toner charge amount is constant, it is effective to change the development contrast to control the amount of toner particles held by the photosensitive member. In other words, the image density can be controlled by adjusting the development contrast.

According to the patch detection ATR, it is necessary to obtain a deviation amount between the density of a toner patch and a predetermined density. Therefore, as illustrated in FIG. 16B, a conventional apparatus controls the development contrast for forming the toner patch to be a constant value (hereinafter, referred to as “patch Vcont”). When a toner patch is formed, toner particles corresponding to the electric charge equivalent to the patch Vcont can adhere to the photosensitive member.

If the toner charge amount immediately after the power source is turned on is less than a desired value, a relatively large amount of toner particles can adhere to the photosensitive member compared to a case where the toner charge amount is equal to the desired value. Therefore, a toner patch having a density higher than a desired density is formed (see point C in FIG. 16C).

If it is determined that the density of the toner patch is higher than the desired density, the apparatus performs control for reducing the amount of toner to be replenished into the developing unit. Therefore, the toner density of the developing unit decreases in a period between point C and point D (see FIG. 16D).

Although the toner density was an ideal value at the turn-on timing of the power source, the toner density starts deviating from the ideal value and is greatly reduced because of the above-described reducing control of the replenishment toner amount. If the apparatus performs image forming processing after the above-described control, the apparatus may output an image having a density different from that of an input image.

To solve the above-described problem, it may be useful to postpone the image forming processing until the toner charge amount restores the desired value while the developing unit stirs the toner particles. However, users are kept waiting for a relatively long time until the toner charge amount restores the desired value. This is very inconvenient for the users because the apparatus does not smoothly start image forming processing.

### SUMMARY OF THE INVENTION

Exemplary embodiments of the present invention are directed to a technique capable of overcoming or at least mitigating the above-described problems.

Exemplary embodiments of the present invention are directed to an image forming apparatus that can stabilize the density of an output image by appropriately controlling the amount of toner to be supplied, even in a state where the toner charge amount is reduced.

According to an aspect of the present invention, at least one exemplary embodiment is directed to an image forming apparatus, including an image carrier; an exposure unit configured to form an electrostatic latent image on the image carrier; a developing unit including a toner containing unit configured to accommodate a predetermined amount of toner, a toner supply unit configured to supply replenishment toner into the toner containing unit, a stirring unit configured to stir the toner to impart electric charge to the toner, a toner carrying member configured to carry the toner charged by the stirring unit, and a bias applying unit configured to apply a developing bias to the toner carrying member to develop the electrostatic latent image formed on the image carrier with the toner carried by the toner carrying member so as to have a density according to a potential difference between the developing bias and the electrostatic latent image; a density sensor configured to detect a density of a toner pattern developed by the developing unit; and a control unit configured to control an amount of the toner supplied to the toner containing unit by the toner supply unit based on the density of the toner pattern detected by the density sensor, wherein the control unit changes the potential difference so that a toner pattern having a predetermined density can be formed when the stirring unit starts stirring the toner.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments and features of the invention and, together with the description, serve to explain at least some of the principles of the invention.

FIG. 1 is a cross-sectional view illustrating an image forming apparatus according to an exemplary embodiment.

FIG. 2 is a block diagram illustrating a reader unit of the image forming apparatus according to an exemplary embodiment.

FIG. 3 is a timing diagram illustrating control signals of a reader image processing unit.

FIG. 4 is a block diagram illustrating a printer unit of the image forming apparatus according to an exemplary embodiment.

FIG. 5 illustrates an example toner patch formed on a photosensitive drum.

FIG. 6 is a block diagram illustrating an example configuration for converting data read by a density sensor into image density data.

FIG. 7 is a graph illustrating a relationship between the output of a density sensor and the density of an output image.

FIGS. 8A, 8B, 8C, and 8D illustrate temporal changes in toner charge amount, patch Vcont, patch density, and toner density.

FIG. 9 is a flowchart illustrating example patch Vcont control that can be executed by the image forming apparatus according to a first exemplary embodiment.

FIG. 10 is a flowchart illustrating example calibration that can be executed by the image forming apparatus according to a second exemplary embodiment.

FIG. 11A is a graph illustrating a table usable for conversion between patch value difference and development contrast correction value.

FIG. 11B is a graph illustrating a table usable for conversion between the development contrast correction value and laser power correction value.

FIG. 12 illustrates an image pattern to be printed on a recording material in the calibration and the density of the image pattern.

FIG. 13 is a graph illustrating a relationship between development contrast (V) and image density.

FIGS. 14A, 14B, 14C, 14D, 14E, and 14F illustrate temporal changes in toner charge amount, patch Vcont, patch density, toner density, image Vcont, and image density in the image forming apparatus according to the second exemplary embodiment.

FIG. 15 is a flowchart illustrating patch Vcont/image Vcont control that can be executed by the image forming apparatus according to the second exemplary embodiment.

FIGS. 16A, 16B, 16C, and 16D illustrate temporal changes in the toner charge amount, patch Vcont, patch density, and toner density in a conventional image forming apparatus.

FIGS. 17A, 17B, 17C, 17D, 17E, and 17F illustrate temporal changes in toner charge amount, patch Vcont, patch density, toner density, image Vcont, and image density in a conventional image forming apparatus.

FIG. 18 is a graph illustrating an example correction table that can be used to correct a γ correction circuit.

### DETAILED DESCRIPTION OF THE EMBODIMENTS

The following description of exemplary embodiments is illustrative in nature and is in no way intended to limit the invention, its application, or uses. It is noted that throughout the specification, similar reference numerals and letters refer to similar items in the following figures, and thus once an item is described in one figure, it may not be discussed for following figures. Various exemplary embodiments, features, and aspects of the invention will be described in detail below with reference to the drawings.

As described above, in a case where the power source of an image forming apparatus is turned off or when the apparatus is in a standby state (e.g., in a power saving mode) even through the power source of the image forming apparatus is turned on, toner particles are not stirred and therefore cannot be charged. Therefore, immediately after the power source is turned on or immediately after the apparatus has been restored from the standby state, the toner charge amount is less than the desired charge amount.

If the image forming apparatus forms a toner patch (i.e., a toner pattern) in a state where the toner charge amount is lower than the desired charge amount by a predetermined value or more, the formed toner patch may have a density higher than a predetermined value. When the density of the toner patch is high, the image forming apparatus reduces the amount of toner to be supplied to a developing unit. Therefore, the toner density of the developing unit reduces and, as a result, the density of an output image decreases. To solve the above-described problem, the image forming apparatus according to the present exemplary embodiment performs the following control.

More specifically, if the apparatus performs the toner density control based on the patch detection ATR in a state where the toner charge amount is low immediately after the power source is turned on, the apparatus reduces the development contrast (hereinafter, referred to as “patch Vcont”) from a first potential difference Y1 to a second potential difference Y2, in order to form a toner patch according to a reduction X (μC/g) of the toner charge amount.

After completing the control for reducing the patch Vcont to the second potential difference Y2, the apparatus newly forms a toner patch every time image forming processing of a predetermined number of sheets is finished. If the density of the newly formed toner patch is different from a predetermined density, the apparatus controls the toner supply amount based on the toner patch density and the predetermined density.

The apparatus further controls the patch Vcont so that the next formed toner patch has a predetermined density. The image forming apparatus according to an exemplary embodiment of the present invention is described below with reference to the drawings.

In the following exemplary embodiment, the present invention is described based on an image forming apparatus using a two-component developer. However, the present invention is also applicable to an image forming apparatus using a one-component developer.

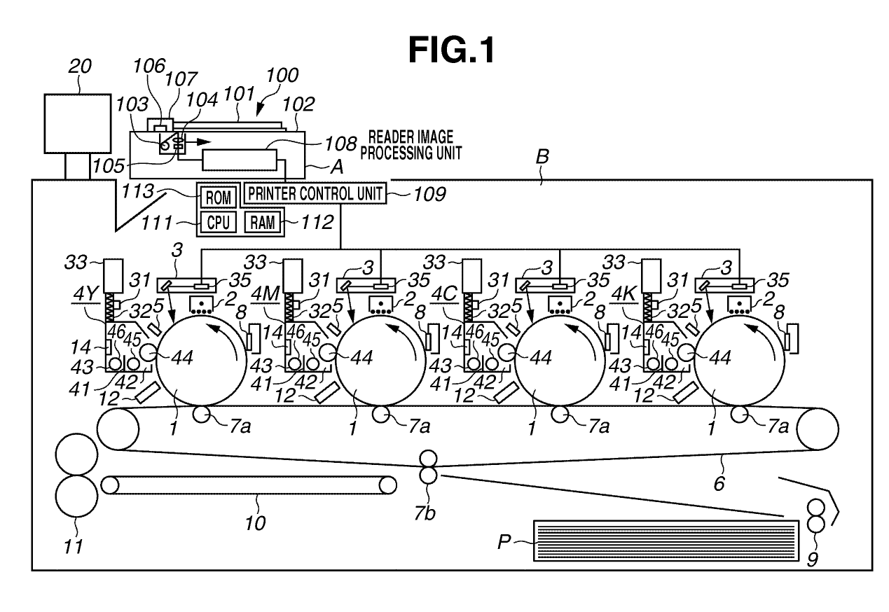

The image forming apparatus according to the first exemplary embodiment has the following configuration and can perform the following operations. FIG. 1 is a cross-sectional view illustrating the image forming apparatus according to the first exemplary embodiment. An image forming apparatus 100 according to the present exemplary embodiment is a full-color (e.g., four-color) electrophotographic printer. The image forming apparatus 100 includes a reader unit A and a printer unit B.

In the reader unit A, a document 101 is placed on a document positioning glass plate 102 in a state where an image-formed surface of the document 101 faces downward. The document 101 is irradiated with light from a light source 103 and its optical image is captured by a CCD sensor 105 via an optical system 104. The CCD sensor 105, including red (R), green (G), and blue (B) CCD line sensor groups arrayed in three lines, can generate three-color (i.e., red, green, and blue) component signals for each line sensor.

The above-described light source 103, the optical system 104, and the CCD sensor 105, which cooperatively constitute an optical reading unit, perform scanning in a direction indicated by an arrow to convert the scanned document 101 into electric signal data string for each line.

An abutting member 107 is provided on the document positioning glass plate 102. When the document 101 collides against the abutting member 107, the abutting member 107 prevents the document 101 from inclining relative to the document positioning glass plate 102. A reference white board 106 is disposed on the surface of the document positioning glass plate 102. The reference white board 106 can be used to determine a white level of the CCD sensor 105, or can be used to perform shading of the CCD sensor 105 in the thrust direction.

The image signal obtained by the CCD sensor 105 is processed by a reader image processing unit 108 and is transmitted to the printer unit B. In the printer unit B, a printer control unit (i.e., a printer image processing unit) 109 can perform image processing.

The document reading method according to the present exemplary embodiment is not limited to the above-described method for reading a document placed on a document positioning plate. For example, it may be useful to cause the CCD sensor 105 to read a document while the document is automatically conveyed by a sheet conveyance device.

The printer unit B includes an operation unit 20 that enables users to input various print conditions (e.g., type of image, number of copies, etc.). The printer unit B performs image forming processing according to a user's instruction entered via the operation unit 20.

The printer unit B includes a plurality of photosensitive drums 1 (i.e., electrophotographic photosensitive drum members) that can serve as image carriers. Each photosensitive drum 1 can rotate in the counterclockwise direction (i.e., a direction indicated by an arrow) when it is driven by a driving apparatus (not illustrated).

A primary charging device 2 can uniformly charge the surface of the photosensitive drum 1 when the drum 1 is rotating. In the present exemplary embodiment, the primary charging device 2 is a scorotron charging device. The scorotron charging device includes a wire to which a higher voltage is applied, a shielding portion connected to the earth, and a grid portion to which a desired voltage is applied.

The photosensitive drum 1 can be charged to have an electric potential corresponding to the voltage applied to the grid portion, although the charge potential is dependent on the voltage applied to the wire. A charging bias power source (not illustrated) can apply a predetermined charging bias to the wire of the primary charging device 2. A grid bias power source (not illustrated) can apply a predetermined grid bias to the grid portion of the primary charging device 2.

The printer unit B includes a plurality of exposure devices 3. Each exposure device 3 includes a semiconductor laser (not illustrated) serving as a laser beam source and a deflector 3a (i.e., a polygonal mirror) that can deflect the laser beam emitted from the semiconductor laser to perform scanning on the photosensitive drum 1. For example, the exposure device (i.e., a laser scanner) 3 irradiates the photosensitive drum 1 dedicated to yellow (i.e., first color) with a laser beam according to an image pattern of yellow. Thus, an electrostatic image (i.e., an electrostatic latent image) of the first color image can be formed on the surface of the first photosensitive drum 1. Similarly, electrostatic latent images of the second to fourth colors (e.g., magenta, cyan, and black) can be formed on the photosensitive drums 1 dedicated to respective colors.

A developing unit 4 can develop the electrostatic latent image formed on the photosensitive drum 1. In the image forming apparatus 100 according to the present exemplary embodiment, the developing unit 4 is a two-component developing unit that uses a two-component developer. The developing unit 4 is disposed at a predetermined developing position where the developing unit 4 confronts with the photosensitive drum 1. The developing unit 4 has an internal space divided into a first chamber (i.e. first toner containing unit) 42 and a second chamber (i.e., second toner containing unit) 43, which are separated by a partition wall 41 extending in the vertical direction at the developing position. Each of the first chamber 42 and the second chamber 43 can serve as a toner storing unit. A non-magnetic developing sleeve 44 (i.e., a developer carrying member) is disposed in the first chamber 42. A magnet is fixed in the developing sleeve 44.

A first screw 45 (i.e., a first stirring unit) is disposed in the first chamber 42. A second screw 46 (i.e., a second stirring unit) is disposed in the second chamber 43. The first screw 45 stirs the developer stored in the first chamber 42 and conveys the developer into the second chamber 43. When the developer is stirred by the first screw 45 and the second screw 46, toner particles can repetitively contact carrier particles. In this case, due to friction, the toner particles are charged to have a negative potential while the carrier particles are charged to have a positive potential. If the amount of the carrier particles is large compared to the amount of the toner particles, i.e., when the toner density is less than a desired value, the number of times that the toner particles can contact the carrier particles increases. Therefore, the toner charge amount becomes larger than a desired value.

On the other hand, if the amount of the carrier particles is small compared to the amount of the toner particles, i.e., when the toner density is high, the number of times that the toner particles can contact the carrier particles decreases. Therefore, the toner charge amount becomes smaller than the desired value. To maintain the toner charge amount at a desired value, the below-described ATR control can be performed so as to maintain the toner density at a desired value.

The second screw 45 stirs (mixes) toner particles, which can be supplied from a toner replenishment tank 33 by a toner conveyance screw 32, with the developer already existing in the developing unit 4. In other words, the second screw 45 can eliminate local differences in the toner density of the developer. The partition wall has a pair of developer passages, which are provided on the front and rear sides of the developing unit 4 illustrated in FIG. 1. The first chamber 42 and the second chamber 43 are connected via the developer passages.

If the toner particles in the first chamber 42 are consumed for the development and the toner density decreases, the developer in the first chamber 42 moves via one passage into the second chamber 43 by the stirring movement (conveyance) of the first and second screws 42 and 43. Meanwhile, the developer whose density has recovered in the second chamber 43 moves via the other passage into the first chamber 42.

The two-component developer in the developing unit 4 can be held around the developing sleeve 44 (i.e., a toner carrying member) under a given magnetic force. A blade serving as a developer regulating member regulates the thickness of a developer layer on the developing sleeve 44 (i.e., on the toner carrying member). When the developing sleeve 44 rotates, the developer is conveyed to a developing area where the developing sleeve 44 can contact the photosensitive drum 1. The developer in the developing area can be supplied to the photosensitive drum 1 to develop an electrostatic image formed on the drum 1.

To improve the developing efficiency (i.e., the toner applying rate to a latent image), a developing bias power source 47 (i.e., a developing bias applying unit) applies a predetermined developing bias to the developing sleeve 44. In the present exemplary embodiment, the developing bias power source 47 applies a developing bias including an AC voltage added on a DC voltage to the developing sleeve 44.

The development contrast indicates a potential difference between the potential of an electrostatic latent image formed on the photosensitive drum 1 and the DC voltage applied to the developing sleeve 44. If the toner charge amount is constant, the development contrast determines an amount of toner particles that can be held on the photosensitive member 1. The electrophotographic image forming apparatus controls the development contrast to control the density of an image. An example method for controlling the development contrast is described below.

In the present exemplary embodiment, toner replenishment tanks 33Y, 33M, 33C, and 33K accommodating replenishment toner particles are attached to the upper portions of respective developing units 4Y, 4M, 4C, and 4K. Toner conveyance screws 32Y, 32M, 32C, and 32K, which are driven by motors 31Y, 31M, 31C, and 31K (each serving as a driving source), are provided at the lower portions of respective replenishment tanks 33Y, 33M, 33C, and 33K. The toner conveyance screws 32Y, 32M, 32C, and 32K can supply the replenishment toner particles to the corresponding developing units 4Y, 4M, 4C, and 4K via toner conveyance paths (not illustrated).

A central processing unit (i.e., CPU) 111 provided in a control unit 110 controls the motors 31Y, 31M, 31C, and 31K via a motor driving circuit (not illustrated) to control the amount of toner particles to be supplied by the toner conveyance screws 32Y, 32M, 32C, and 32K, respectively. A random access memory (i.e., RAM) 112 connected to the CPU 111 can store control data to be supplied to the motor driving circuit. The above-described toner replenishment tanks 33Y, 33M, 33C, and 33K, the motors 31Y, 31M, 31C, and 31K, and the toner conveyance screws 32Y, 32M, 32C, and 32K configure a toner replenishment apparatus 30.

In the present exemplary embodiment, respective components of the toner replenishment apparatus 30 have a similar configuration and perform similar operations irrespective of the colors of respective replenishment toner particles. Therefore, in the following description, suffixes Y, M, C, K respectively indicating the toner colors are omitted unless they are specifically required.

The printer unit B according to the present exemplary embodiment includes yellow, magenta, cyan, and black developing units 4Y, 4M, 4C, and 4K. The developing units 4Y, 4M, 4C, and 4K are filled with two-component developers accommodating yellow, magenta, cyan, and black toner particles, respectively. The two-component developer includes toner particles (T) and carrier particles (C).

The developing unit 4 is equipped with a toner density detection/control device (i.e., a control unit), which can maintain the mixing ratio T/(T+C) of the toner particles (T) and the carrier particles (C), i.e., the toner density of the developer (hereinafter, referred to as “T/(T+C) ratio”), at a constant level. The toner density detection/control device controls the toner density in the developing unit 4 to be a constant value when the toner is supplied from the toner replenishment tank 33.

The electrostatic latent image formed on the photosensitive drum 1 corresponding to each color can be developed into a visible image (i.e., a toner image) by the developing unit 4 disposed in the confronting relationship with the photosensitive drum 1, while the photosensitive drum 1 is rotating.

The toner image formed on the photosensitive drum 1 is then transferred (i.e., primarily transferred) onto an intermediate transfer belt 6, which is a belt-like intermediate transfer member, by the function of a primary transfer roller 7a. At this moment, a primary transfer bias power source (not illustrated) applies a primary transfer bias to the primary transfer roller 7a. The primary transfer bias has a polarity opposed to the regular charging polarity of the toner. The intermediate transfer belt 6 can move in a predetermined direction to make clockwise rotation at a rotational speed similar to that of the photosensitive drum 1.

A full-color toner image (i.e., a combination of toner images of respective colors) can be formed on the intermediate transfer belt 6 by performing the above-described charging, exposure, development, and primary transfer processes for respective (i.e., yellow, magenta, cyan, and black) colors.

The four-color toner images transferred on the intermediate transfer belt 6 are then transferred (i.e., secondarily transferred) onto the surface of a recording material P by the function of a secondary transfer roller 7b. At this moment, a second transfer bias power source (not illustrated) applies a secondary transfer bias to the secondary transfer roller 7b. The secondary transfer bias has a polarity opposed to the regular charging polarity of the toner. A recording material conveyance device, such as a pair of pickup rollers 9, can convey at predetermined timing the recording material P to an abutting portion where the intermediate transfer belt 6 is brought into contact with the secondary transfer roller 7b.

A conveyance belt 10 can send the recording material P, which carries the four-color toner images transferred thereon, to a fixing device 11. The fixing device 11 includes a fixing roller equipped with a heating device and a pressing roller to be pressed against the fixing roller. The fixing device 11 performs heating/pressing on the recording material P to fuse and fix the toner particles on the recording material P, thereby obtaining a final full-color image. After the heating/fixing processing on the toner images is completed, the printer unit B discharges the recording material P to the outside.

A cleaning blade 8 scrapes and collects the toner particles remaining on the photosensitive drum 1 after completing the primary transfer.

In the above-described embodiment, the example full-color image forming processing has been described. However, the printer unit B can form a monochromatic image (e.g., a black monochromatic image). In this case, the black developing unit 4B develops an electrostatic latent image of a black image formed on the photosensitive drum 1. Then, as described above, the black toner image formed on the photosensitive drum 1 is finally transferred onto the recording material P and fixed to obtain a black monochromatic printed image.

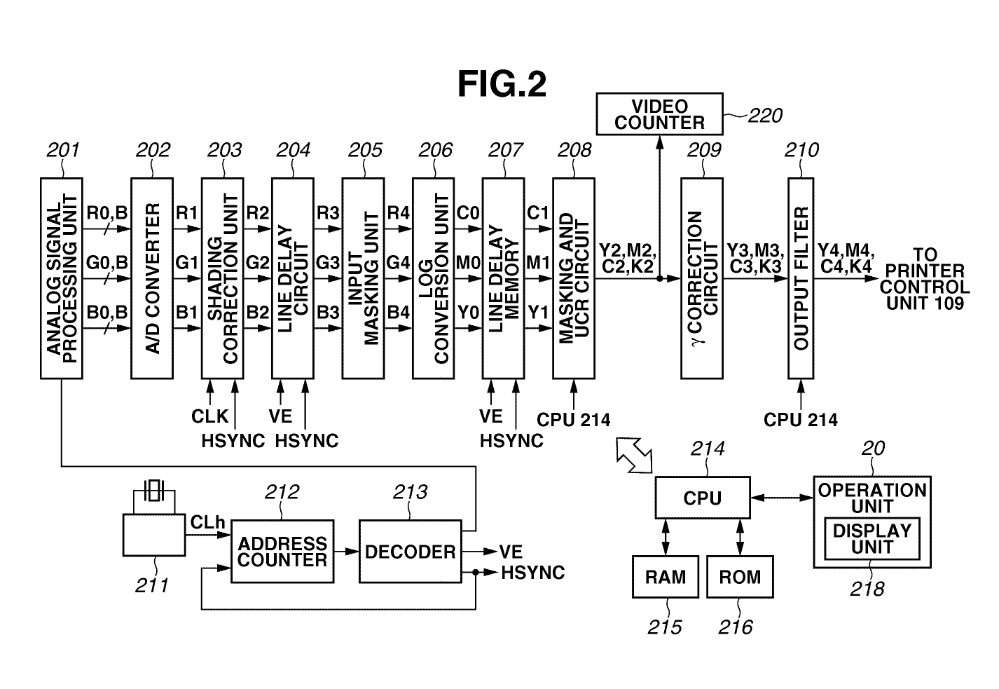

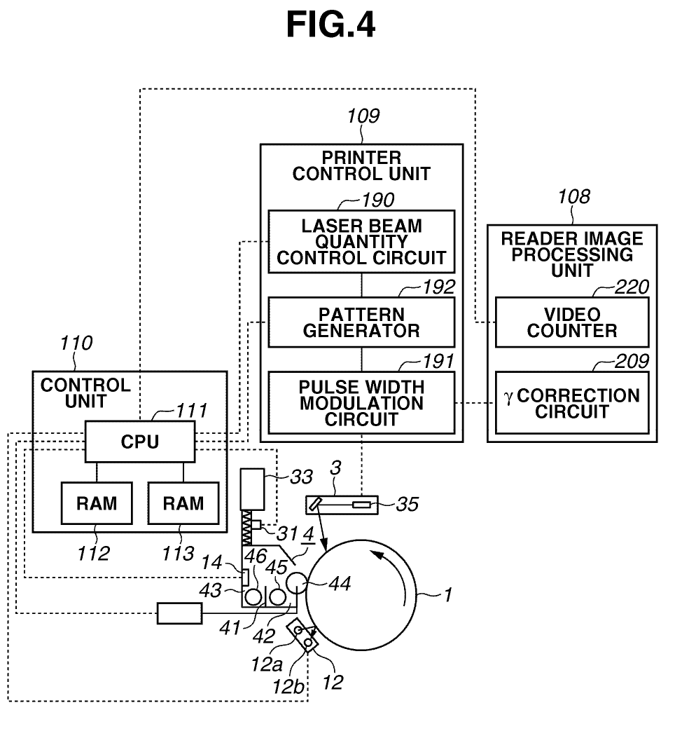

The reader image processing unit 108 processes image data of a document read by the reader unit A, and the printer control unit 109 performs the following operations. FIG. 2 is a block diagram illustrating example processing on image signals that can be performed by the reader image processing unit 108. FIG. 4 is a block diagram illustrating the printer control unit 109 of the printer unit B.

As illustrated in FIG. 2, an analog signal processing unit 201 can receive an image signal output from the CCD sensor 105. The analog signal processing unit 201 can perform gain adjustment and offset adjustment on the input signal. An analog-digital (i.e., A/D) converter 202 can receive the processed signals of respective colors from the analog signal processing unit 201 and can convert the respective signals into 8-bit digital image signals R1, G1, and B1 of respective colors. A shading correction unit 203 can receive the converted signals from the A/D converter 202 and perform shading correction on respective color signals using the reading signal of the reference white board 106 as conventionally known.

A clock generation unit 211 can generate clocks at intervals corresponding to one pixel. A main scanning address counter 212 can count the clocks generated by the clock generation unit 211 and generate a pixel address output of one line.

A decoder 213 can decode a main scanning address supplied from the main scanning address counter 212 and can generate a CCD driving signal (e.g., a shift pulse or a reset pulse) for each line. The decoder 213 can further generate a VE signal and a line sync signal HSYNC. The VE signal represents an effective area contained in a reading signal of one line that can be obtained by the CCD sensor 105. The main scanning address counter 212 can be cleared by the HSYNC signal and starts counting a main scanning address of the next line.

Respective line sensors of the CCD sensor 105 are mutually spaced at predetermined distances. Therefore, a line delay circuit 204 illustrated in FIG. 2 can correct spatial deviations in the sub scanning direction. More specifically, the line delay circuit 204 causes line delay of the R and G signals relative to the B signal in the sub scanning direction.

An input masking unit 205 can convert a reading color space, which can be defined by spectral characteristics of the R, G, and B filters of the CCD sensor 105, into an NTSC standard color space.

To this end, the input masking unit 205 performs matrix calculation defined by the following formula.

$$[ \begin{matrix}R 4 \\ G 4 \\ B 4\end{matrix} ] = [ \begin{matrix}a 11 & a 12 & a 13 \\ a 21 & a 22 & a 23 \\ a 31 & a 32 & a 33\end{matrix} ] [ \begin{matrix}R 3 \\ G 3 \\ B 3\end{matrix} ] \qquad ( 1 )$$

A light quantity/image density conversion unit (i.e., an LOG conversion unit) 206, which can be configured by a look-up table read only memory (i.e., LUT ROM), can convert R4, G4, and B4 luminance signals into M0, C0, and Y0 density signals of magenta (M), cyan (C), and yellow (Y) image signals. A line delay memory 207, which serves as a black character determination unit (not illustrated), can delay the M0, C0, and Y0 image signals by amounts corresponding to the line delays relating to the determination signals of UCR, FILTER, and SEN generated from the R4, G4, and B4 signals.

A masking and UCR circuit 208 can extract a black (K) signal from the three primary color signals M1, C1, and Y1 that are entered from the line delay memory 207. The masking and UCR circuit 208 can further perform calculation for correcting muddy colors of recording color materials used by the printer unit B. Then, the masking and UCR circuit 208 can sequentially output M2, C2, Y2, and K2 signals each having a predetermined bit width (e.g., 8-bit) in each reading operation.

A gamma (i.e., γ) correction circuit 209 can perform image density correction, in the reader unit A, so as to obtain ideal gradation characteristics suitable for the printer unit B. The γ correction circuit 209 can perform density conversion on an input image using a γLUT (i.e., a gradation correction table) that is, for example, configured by a 256-byte RAM. The γ correction circuit 209 can further perform image forming processing based on the converted image density data.

A space filter processing unit (i.e., an output filter) 210 can perform edge intensifying or smoothing processing on M3, C3, Y3, and K3 signals received from the γ correction circuit 209. A video counter 220 receives the M2, C2, Y2, and K2 signals. The video counter 220 can accumulate image density values on a pixel-by-pixel basis, and then calculate a video count value of each image.

The reader unit A further includes a CPU 214, a RAM 215, and a ROM 216, which control various operations to be performed by the reader unit A. The image forming apparatus 100 includes an operation unit 20 provided on the body of the apparatus 100. The operation unit 20 includes a display unit 218. The operation unit 20 is connected to the CPU 214 of the reader unit A and to the CPU 111 of the control unit 110 provided in the printer unit B.

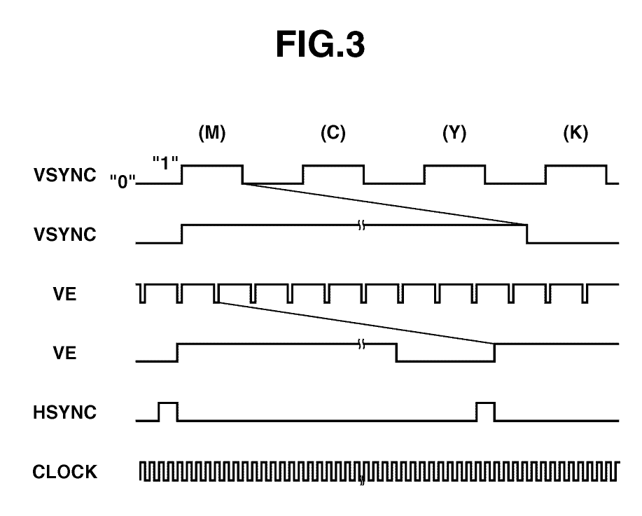

FIG. 3 is a timing diagram illustrating control signals of the reader image processing unit 108 illustrated in FIG. 1. In FIG. 3, a VSYNC signal indicates an image effective period in the sub scanning direction. The reader image processing unit 108 performs image reading (i.e., scanning) processing in respective logical “1” periods to sequentially output M, C, Y, and K signals.

The VE signal indicates an image effective period in the main scanning direction. The reader image processing unit 108 determines timing of a main scanning start position during the logical “1” period of the VE signal. The VE signal can be mainly used for the line-delay line counting control. A CLOCK signal is a pixel sync signal, which can be used to transfer image data at timing when the signal rises from “0” to “1.”

The M4, C4, Y4, and K4 area sequential image signals, having been processed in the above-described manner, are then sent to the printer control unit 109. The printer unit B performs image recording with density gradations that can be realized by the pulse width modulation (i.e., PWM) control.

The printer control unit 109 is described below with reference to FIG. 4. The printer control unit 109 includes a laser beam quantity control circuit 190, a pulse width modulation circuit 191, and a toner patch signal generation circuit (i.e., a pattern generator) 192. The pulse width modulation circuit 191, for each input pixel signal, forms a laser driving pulse having a width (i.e., a time width) corresponding to the level of each input pixel image signal and outputs the laser driving pulse.

More specifically, if the pixel image signal has a higher density, the pulse width modulation circuit 191 forms a driving pulse having a wider width. If the pixel image signal has a lower density, the pulse width modulation circuit 191 forms a driving pulse having a narrower width. If the pixel image signal has an intermediate density, the pulse width modulation circuit 191 forms a driving pulse having an intermediate width.

The laser driving pulse generated from the pulse width modulation circuit 191 is supplied to a laser scanner 3 (i.e., an exposure unit). The laser scanner 3 causes a semiconductor laser to emit light for a predetermined time corresponding to the pulse width of the laser driving pulse. Accordingly, the semiconductor laser is activated for a long time if the pixel density is high and for a short time if the pixel density is low.

Therefore, an optical system provided in the laser scanner 3 controls the laser beam emitted in the main scanning operation in such a manner that a relatively long area of the photosensitive drum 1 can be exposed if the pixel density is high and a relatively short area of the photosensitive drum 1 can be exposed if the pixel density is low. In other words, the dot size of an electrostatic latent image is variable depending on the pixel density. Accordingly, a toner consumption amount corresponding to the high density pixel is larger than a toner consumption amount corresponding to the low density pixel.

The pattern generator 192 generates a toner patch signal corresponding to a predetermined density, as described below.

The toner density detection/control device (i.e., the control unit) controls the toner density in the developing unit 4, in the following manner. The toner density of the developer in the developing unit 4 decreases with increasing consumption of toner particles for the development of electrostatic latent images. Therefore, the toner density detection/control device controls the amount of toner supplied from the toner replenishment tank 33 to the developing unit 4. Thus, the toner density of the developer can be maintained at a constant level and the image density can be also maintained at a constant level.

The image forming apparatus 100 according to the present exemplary embodiment includes the toner density detection/control device of the patch detection ATR type, which can form an image of a reference toner patch on the photosensitive drum 1 (i.e., on the image carrier) and detect the image density with an image density sensor 12 disposed in an opposed relationship with the photosensitive drum 1. The image density sensor 12 may be disposed in the confronting relationship with the intermediate transfer member so that the image density sensor 12 can read the toner patch on the intermediate transfer member.

The toner density detection/control device of the patch detection type can perform the following toner density control.

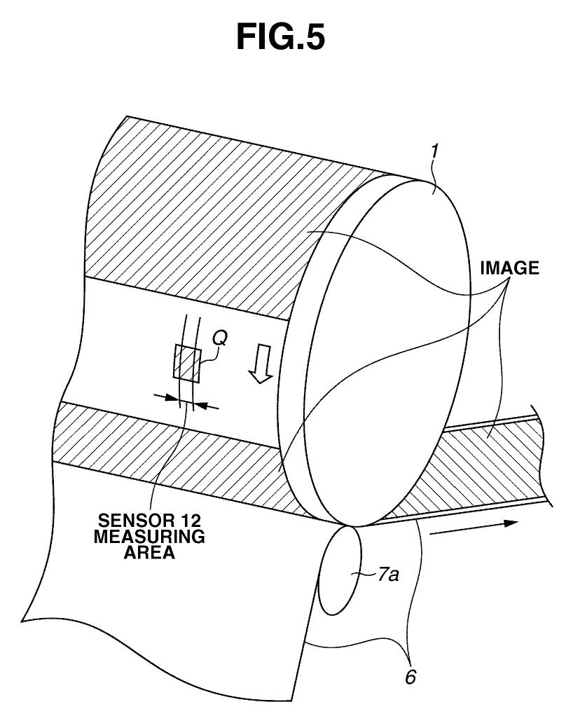

The CPU 111 of the image forming apparatus according to the present exemplary embodiment forms an electrostatic latent image of a toner patch (i.e., a patch latent image) in a non-image area (hereinafter, referred to as ““between images””) between the rear end of a latent image of a preceding image and the front end of a latent image of a subsequent image that are formed continuously as illustrated in FIG. 5. When the patch latent image is developed with toner particles, a toner patch Q (i.e., a toner pattern) can be formed on the photosensitive drum 1. The toner patch Q can be use to control the toner density.

As described above, the printer control unit 109 includes the toner patch signal generation circuit (i.e., the pattern generator) 192 that can generate the toner patch signal that can form a toner patch having a predetermined density. The pattern generator 192 supplies the generated toner patch signal to the pulse width modulation circuit 191. The pulse width modulation circuit 191 generates a laser driving pulse having a pulse width corresponding to the above-described predetermined density.

The laser driving pulse is supplied to the laser scanner 3. The laser scanner 3 causes its semiconductor laser to emit light for a predetermined time corresponding to the pulse width to scan and expose the photosensitive drum 1. Through the scanning and exposure processing, a patch latent image corresponding to the above-described predetermined density can be formed on the photosensitive drum 1. Then, the patch latent image is developed by the developing unit 4 and the toner patch Q is formed on the photosensitive drum 1.

If the density of the toner patch Q is higher than the predetermined density, the CPU 111 determines that the toner density is high and reduces the toner supply amount. If the density of the toner patch Q is lower than the predetermined density, the CPU 111 determines that the toner density is low and increases the toner supply amount. The above-described operations can be performed according to the conventional patch detection ATR.

The present exemplary embodiment performs the patch detection ATR in the following manner. Although the patch Vcont is generally controlled to be a constant value when the toner patch Q is formed, the present exemplary embodiment controls the patch Vcont. The development contrast is determined according to a relationship between a primary charge bias applied to the primary charging device 2, a DC component of the developing bias applied to the developing sleeve 44, and an exposure amount of light emitted to the photosensitive drum 1.

The development contrast can be changed by changing any one of the above-described factors. In the present exemplary embodiment, the biases applied to the primary charging device 2 and the developing sleeve 44 are fixed while the exposure amount of light emitted to the photosensitive drum 1 is controlled to change the patch Vcont. More specifically, the present exemplary embodiment controls the patch Vcont by changing the power of the laser beam in the ordinary image region and in the patch latent image formation between images.

For the control of the patch Vcont in the formation of the toner patch Q, the laser power is determined in such a manner that the density of the toner patch Q can be equalized with a target density (e.g., 0.8). For example, image areas of 200 levels can be set. The potential can be measured by appropriately changing the laser power. The laser power can be determined in such a manner that the potential of an electrostatic latent image for forming the toner patch Q becomes a target potential. The above-described control for determining the toner patch Q forming laser power can be referred to as “patch potential control.”

In the present exemplary embodiment, to control the patch Vcont, the CPU 111 changes the laser power according to the following formula.

Laser Power=Laser Power_ref+α

The laser power_ref represents reference laser power in a state where the laser power control is not executed.

If the development contrast is greatly changed, a difference in the tint may be visually recognized. Therefore, it is desired to set upper and lower limits in a variation so that the development contrast can change within a limited range. In general, if the tint difference ΔE is equal to or less than 3 (i.e., ΔE≦3), it is difficult for human eyes to perceive a change in the tint. As a result, such a change is not recognized.

Accordingly, it is desired to control the value a in the above-described formula so as to satisfy the requirement (i.e., tint difference ΔE≦3) in each development contrast change operation. A colorimeter can be used to measure the tint difference ΔE of respective color images, when these color images are output.

For example, if chromaticity L*a*b values of an output image are measured with the calorimeter X-Rite 530 provided by X-Rite Corporation, the tint difference ΔE can be calculated according to the following formula.

E=\sqrt{( L)²+( a)²+( b)²} (2)

The quantity of reflection light from the toner patch Q formed on the photosensitive drum 1 can be measured with the image density sensor 12. The image density sensor 12 includes a light-emitting portion 12a equipped with a light emitting element (e.g., light-emitting diode (LED)) and a light-receiving portion 12b equipped with a light-receiving element (e.g., a photodiode (PD)).

The image density sensor 12 measures the quantity of the above-described reflection light at timing when the toner patch Q formed “between images” on the photosensitive drum 1 passes under the image density sensor 12. The CPU 111 inputs a signal representing a measurement result from the image density sensor 12. Then, the CPU 111 obtains a correction amount (which is described below) of the replenishment toner amount that is required to attain a desired density (i.e., reflection light quantity).

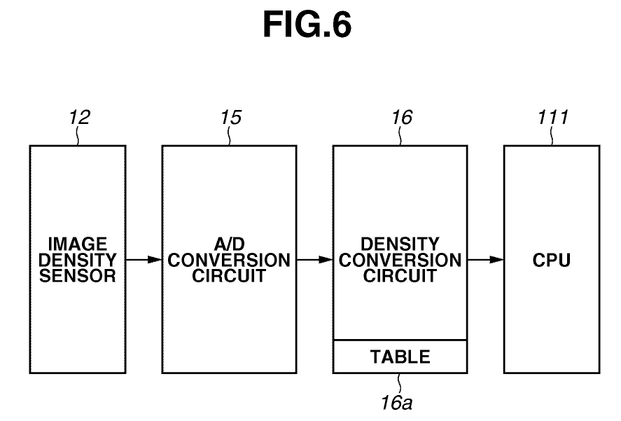

FIG. 6 is a block diagram illustrating an example of a circuit configuration that can process an output signal of the above-described image density sensor 12. The image density sensor 12 converts the reflection light (i.e., near-infrared light) from the photosensitive drum 1 into an electric signal.

An analog-digital (i.e., A/D) conversion circuit 15 provided in the control unit 110 can convert an input electric signal (e.g., 0 to 5 V) into an 8-bit digital signal. A density conversion circuit 16 provided in the control unit 110 can convert the digital signal into density information.

An example control for replenishing yellow, magenta, and cyan toner particles is described below. The toner of each color includes color materials dispersed in a styrene-based copolymer resin that serves as a binder. The photosensitive drum 1 is made of an organic photoconductor (i.e., OPC) photosensitive member having a reflectance of approximately 40% with respect to near-infrared light (960 nm). However, the photosensitive drum 1 can be made of an amorphous silicon-based photosensitive member that has a similar reflectance. In the present exemplary embodiment, the image density sensor 12 is configured to detect only the positive reflection light from the photosensitive drum 1.

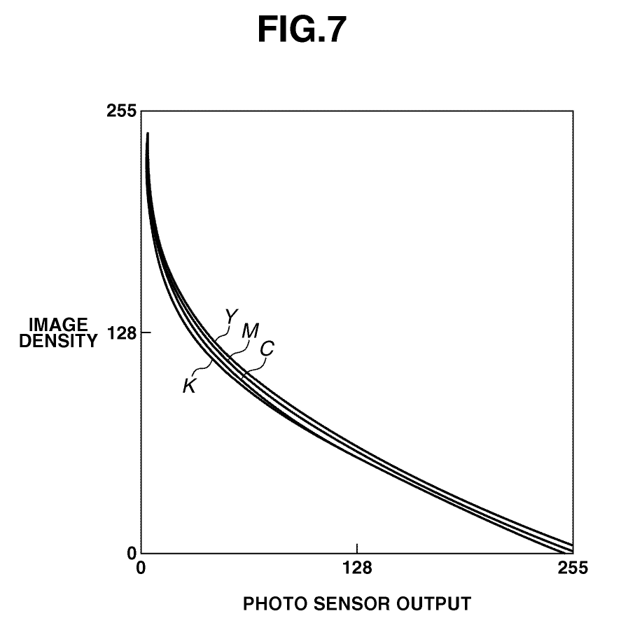

FIG. 7 illustrates a relationship between the output of the image density sensor 12 and the density of an output image in a case where the toner patch Q is formed on the photosensitive drum 1 with stepwise changes in the density according to the area gradations of respective colors. The output of the image density sensor 12 is set to 5V, i.e., level 255, in a state where toner particles do not adhere to the photosensitive drum 1.

As illustrated in FIG. 7, the output of the image density sensor 12 decreases with increasing image density, i.e., when the area covering ratio of toner particles increases. A table 16a dedicated to each color is prepared beforehand to convert the output of the image density sensor 12 into a density signal based on the above-described characteristics of the image density sensor 12. The density conversion circuit 16 stores the table 16a in its storage unit. Thus, the density conversion circuit 16 can accurately read the image density of each color. The density conversion circuit 16 outputs the obtained density information to the CPU 111.

In the present exemplary embodiment, the apparatus is configured to set the density of the toner patch Q signal to level 128 (i.e., 0.8 in the density) of 255 levels through the toner density control based on the patch detection ATR. Therefore, the density of the toner patch Q should be equal to 0.8. However, image characteristics of the image forming apparatus 100 tend to vary constantly. Therefore, a measurement result with respect to the density of the toner patch Q by the image density sensor 12 may not be always equal to 0.8.

For example, if the toner patch Q is formed in a state where the toner charge amount is low immediately after the power source of the image forming apparatus is turned on, the formed toner patch Q may have a higher density (e.g., 0.9). On the other hand, if the toner patch Q is formed with an increased toner charge amount due to a change in humidity, the formed toner patch Q may have a lower density (e.g., 0.7).

Accordingly, the CPU 111 controls the amount of toner to be supplied into the developing unit 4 based on a deviation ΔD (e.g., ±0.1 according to the above-described examples) between a reference density signal (i.e., the predetermined density 0.8) of the toner patch Q obtained in the initial setting and a measurement result (i.e., the density of the toner patch Q). Through the control performed by the CPU 111, the toner density of the developing unit 4 can be substantially maintained at a predetermined level although the actual toner density may contain a small amount of ripple component.

The image forming apparatus according to the present exemplary embodiment has the following characteristic features. If the above-described toner density control based on the patch detection ATR is performed in a state where the toner charge amount is reduced, an output of the image density sensor 12 indicates that the toner patch has a higher density. Therefore, to correct the toner density, the CPU 111 performs the control for reducing the amount of toner to be supplied, even when the toner density is equal to a desired density. In such a case, the toner density deviates from the desired value and the output image density decreases.

The toner charge amount reduced state is, for example, a state immediately after the power source of the image forming apparatus is again turned on after a relatively long dwell time, or a state immediately after the developing unit 4 has been restored from the power saving mode lasting for a relatively long time. In such cases, toner particles are not stirred for a long time. Therefore, toner charge amount decreases continuously. In both cases, the screws 45 and 46 provided in the developing unit 4 do not stir the toner particles and therefore the toner charge amount decreases.

In this respect, the image forming apparatus according to the present exemplary embodiment is configured to control the patch Vcont if the CPU 111 determines that the toner charge amount is less than the desired value. Therefore, even in the toner charge amount reduced state, the image forming apparatus can supply an appropriate amount of toner into the developing unit 4 so as to constantly maintain the toner density at a desired level.

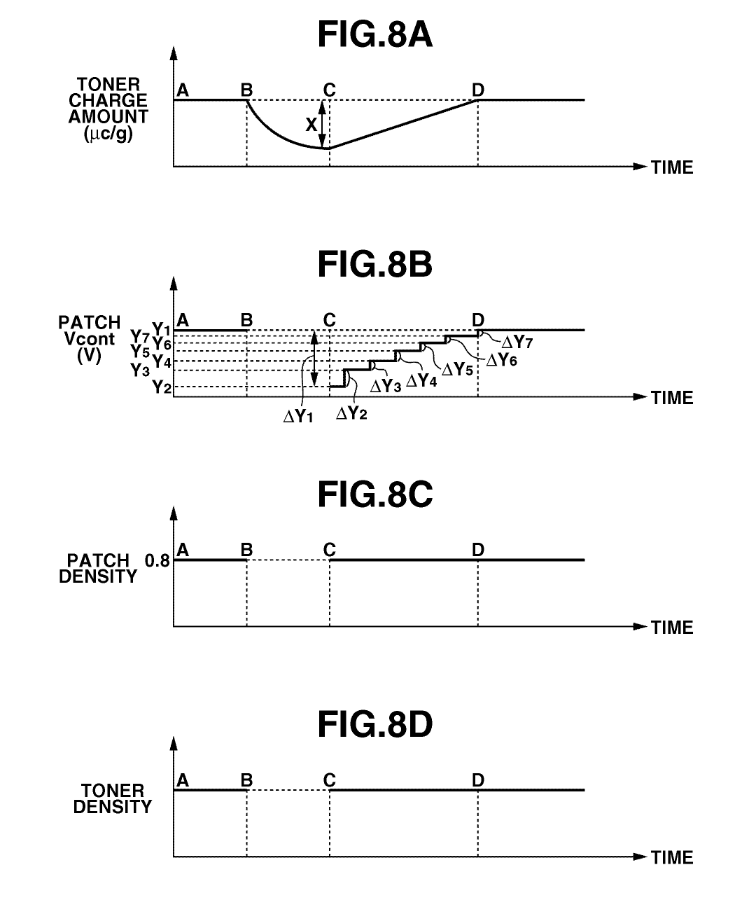

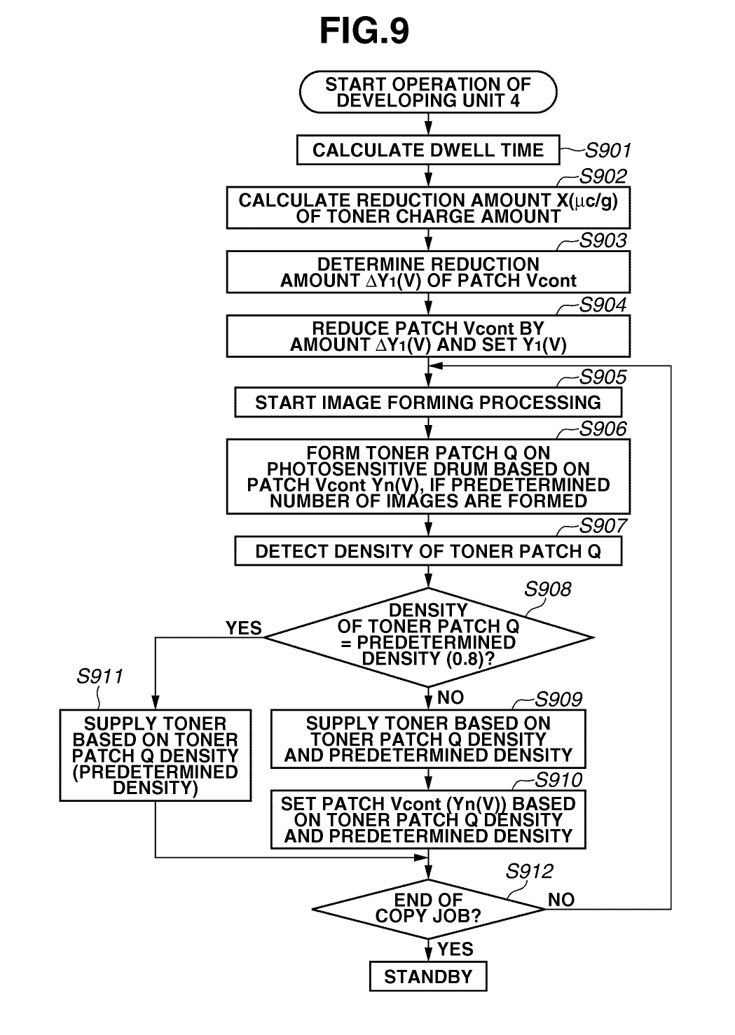

The patch Vcont control method according to the present exemplary embodiment is described below in more detail with reference to FIGS. 8 and 9.

FIG. 8A illustrates a temporal change in the toner charge amount. FIG. 8B illustrates the potential of the patch Vcont. FIG. 8C illustrates the patch density during the control of the patch Vcont. FIG. 8D illustrates the toner density. In the present exemplary embodiment, it is assumed that values in the period from point A to point B illustrated in FIGS. 8A to 8D are ideal values of the toner charge amount, patch Vcont, patch density, and toner density.

The power source of the image forming apparatus 100 is in an ON state between point A and point B and after point C. On the other hand, the power source of the image forming apparatus is in an OFF state between point B and point C. When the power source is turned off, the toner particles are not stirred in the developing unit.

Therefore, as illustrated in FIG. 8A, the toner charge amount decreases continuously in the power-off period between point B and point C. Then, at the time when the power source is again turned on (i.e., point C), the toner charge amount is in a greatly reduced state compared to the desired value. Even after the developing unit starts stirring the toner particles, the toner charge amount cannot immediately be restored to the original level.

In the image forming apparatus according to the present exemplary embodiment, the CPU 111 obtains (measures) an actual dwell time between a stop of a toner stirring operation and a restart of the toner stirring operation. Then, the CPU 111 determines a reduction X (μC/g) in the toner charge amount based on a relationship between the dwell time and the reduction in the toner charge amount, which is stored beforehand.

In the present exemplary embodiment, the ROM stores the table indicating the relationship between non-operation time of the developing unit 4 and the toner charge amount. The reduction in the toner charge amount is variable depending on temperature, humidity, and other environmental conditions. Therefore, the ROM stores a plurality of tables differentiated considering various environmental conditions. The CPU 111 can select an appropriate table based on detected temperature, humidity, and other environmental values, which can be detected by environmental sensors (not illustrated).

Then, based on the reduction X (μC/g) in the toner charge amount obtained according to the above-described method, the CPU 111 reduces the patch Vcont from first patch Vcont Y1 (i.e., first potential difference) to second patch Vcont Y2 by an amount ΔY1 (V) (see FIG. 8B). When the patch Vcont decreases to the patch Vcont Y2, the toner patch Q can be formed with the desired density (i.e., 0.8). As the toner patch Q has the desired density, the toner replenishment amount can be maintained at the ideal value (i.e., the value maintained immediately before the power source is turned off). The toner density can be also maintained at the ideal level.

After the toner stirring operation restarts, the toner charge amount increases continuously. In the present exemplary embodiment, the CPU 111 determines an increase in the toner charge amount based on the density of a periodically formed toner patch Q. The CPU 111 increases the patch Vcont from the second patch Vcont Y2 to a third Vcont Y3 based on the obtained increase in the toner charge amount.

The CPU 111 forms the toner patch Q based on the second patch Vcont every time image formation for a predetermined number of recording media is accomplished. The toner patch Q is formed between sheets every time image formation of a predetermined number of sheets (e.g., every 24 sheets) is accomplished. The CPU 111 determines whether the toner charge amount has restored its original value based on a change in the density of the toner patch Q.

FIG. 8B illustrates an example control for successively increasing the patch Vcont by an amount ΔYn (V) according to restoration of the toner charge amount. The CPU 111 compares the density of the toner patch Q with the predetermined density. If the compared densities are different from each other (or when the density of the toner patch Q is not within a predetermined range), the CPU 111 controls the amount of toner to be supplied into the developing unit 4 based on the density of the toner patch Q and the predetermined density. The CPU 111 further performs control for increasing or decreasing the patch Vcont by an amount of ΔYn (V) based on a comparison result between the density of the toner patch Q and the predetermined density, so that the toner patch Q can be formed with the predetermined density.

A stepwise change in the patch density illustrated in FIG. 8C indicates that the patch Vcont is currently controlled. Every time when it is determined that the density of the toner patch Q is lower than the predetermined density, the CPU 111 increases the patch Vcont by an amount ΔY2 (V) and increases the patch Vcont from Y2 (V) (i.e., second potential difference) to Y3 (V) (i.e., third potential difference). In the present exemplary embodiment, the CPU 111 repetitively performs the above-described control until the value Yn (V) finally restores the ideal value Y1 (V) (i.e., first potential difference).

Accordingly, the toner patch Q having the predetermined density can be constantly formed even when the toner charge amount changes. The toner supply operation can be appropriately performed. If it is determined that the density of the toner patch Q is higher than the predetermined density, the CPU 111 performs control for reducing the patch Vcont Yn (V) by an amount ΔYn (V).

An example control that can be executed by the CPU 111 is described below with reference to FIG. 9. In step S901, the CPU 111 obtains a dwell time of the image forming apparatus and the developing unit in response to a power-on of the image forming apparatus 100 or at the time when the image forming apparatus 100 has been restored from the standby state.

In step S902, the CPU 111 determines the reduction X (μC/g) in the toner charge amount based on the relationship between the dwell time stored beforehand and the toner charge amount. In step S903, the CPU 111 obtains the reduction ΔY1 (V) of the patch Vcont based on the determination result in step S902. In step S904, the CPU 111 reduces the patch Vcont by the amount ΔY1 (V) and sets it to the level of Y1 (V). In step S905, the CPU 111 causes the printer unit B to start image forming processing.

If the image formation for the predetermined number of recording media is completed, then in step S906, the printer unit B forms the toner patch Q on the photosensitive drum 1 based on the patch Vcont Y1. In step S907, the CPU 111 causes the density sensor 12 to detect reflection light from the toner patch Q formed in step S906 and calculates the density of the toner patch Q based on a detection result. In step S908, the CPU 111 determines whether the calculated density of the toner patch Q is equal to the predetermined density.

If it is determined that the density of the toner patch Q is different from the predetermined density (NO in step S908), then in step S909, the CPU 111 supplies toner particles from the toner replenishment tank 33 to the developing unit 4 based on the density of the toner patch Q and the predetermined density. Further, in step S910, the CPU 111 controls the laser power of the semiconductor laser to adjust the patch Vcont in such a way as to equalize the density of the toner patch Q with the predetermined density. The control amount in this case is equal to the above-described ΔYn.

If it is determined that the density of the toner patch Q is equal to the predetermined density (YES in step S908), then in step S911, the CPU 111 supplies toner particles from the toner replenishment tank 33 to the developing unit 4 based on the density of the toner patch Q (i.e., the predetermined density). In this case, the CPU 111 does not control the patch Vcont.

As another determination method usable in step S908, the CPU 111 can determine whether the density of the toner patch Q is within the range of ±0.05 relative to the predetermined density (=0.8).

After step S910 or step S911, the processing proceeds to step S912, in which the CPU 111 determines whether a copy job has been completed. If it is determined that the copy job has been completed (YES in step S912), then in step S913, the CPU 111 brings the image forming apparatus 100 into the standby state. If it is determined that the copy job is not yet completed (NO in step S912), the processing returns to step S905. The CPU 111 causes the printer unit B to start image forming processing.

After the timing of point D illustrated in FIGS. 8A to 8D, the toner charge amount is in a stable state where the toner charge amount is equal to the desired value. After the timing of point D, the density of a newly formed toner patch Q is not so largely changed because the toner charge amount is in the vicinity of the desired value.

Hence, if the number of times that the density of the detected toner patch Q is equal to the desired density exceeds a predetermined value, the CPU 111 can determine that the toner charge amount has completely restored its original value. And, the CPU 111 can terminate the control of the patch Vcont. For example, in a case where the above-described number of times is set to 10, the CPU 111 terminates the control of the patch Vcont if the density of the toner patch Q does not deviate from a predetermined density during the image formation of 240 sheets.

In the present exemplary embodiment, the CPU 111 controls the patch Vcont so as to form a toner patch having a predetermined density regardless of variation in the toner charge amount. Therefore, the toner supply amount can be maintained until the toner charge amount restores its ideal value. However, the CPU 111 may control the patch Vcont to be a constant value while allowing the target density of the toner patch to be variable so as to maintain the toner supply amount.

Namely, the toner patch density is variable according to a change in the toner charge amount. The CPU 111 sets the density of the detected toner patch as a target value of the next formed patch. Therefore, the density of the toner patch is substantially equal to the target density. The toner supply amount can be maintained at a desired value without being reduced greatly.

By performing the above-described control, the toner supply operation can be stably performed even when the toner charge amount is reduced. Therefore, when the image forming apparatus starts its operation immediately after the power source is turned on, the image forming apparatus can stably output an image having a desired density.

In the image forming apparatus according to the first exemplary embodiment, the CPU 111 obtains a reduction in the toner charge amount from the desired charge amount based on the dwell time during which the toner stirring operation is stopped. The CPU 111 controls the patch Vcont based on the obtained reduction. Then, the CPU 111 controls the patch Vcont according to a change in the toner charge amount. The CPU 111 further controls the patch Vcont so that the toner patch Q having a predetermined density can be formed.

In a second exemplary embodiment, the CPU 111 controls the patch Vcont based on a result of potential control that may be performed in calibration or automatic density control that is described below. Therefore, the CPU 111 can more accurately control the patch Vcont. In the second exemplary embodiment, the CPU 111 controls the image Vcont Zn (V) based on the control amount of the patch Vcont Yn (V). Therefore, even when the toner charge amount changes with elapsing time, the CPU 111 can simultaneously realize the control for stabilizing the toner density and the control for stabilizing the density of an output image.

To constantly obtain an output image whose density is stable, it is desired to periodically perform adjustment for the image forming apparatus. Therefore, the image forming apparatus according to the present exemplary embodiment allows users to adjust the image density (hereinafter, referred to as “calibration”). Meanwhile, the image forming apparatus has the capability of performing automatic density control.

According to the above-described calibration, an image pattern (i.e., a gradation toner pattern) having a predetermined density gradation is formed on a recording material based on the development contrast (hereinafter, referred to as “image Vcont”) to form images of predetermined densities. An appropriate reading device, such as the CCD sensor 105 of the reader unit A or a color sensor disposed on the downstream side of the fixing device in the sheet conveyance path, can be used to read the image pattern formed on the recording material. The CPU 111 can adjust the image Vcont based on the reading result. Namely, the CPU 111 performs potential control to control the image density.

The potential control for adjusting the image Vcont of an image to be formed can be performed based on the density of a toner patch formed on a drum and the target density of the toner patch. More specifically, the CPU 111 reduces the image Vcont if the density of the toner patch is higher than a predetermined density. The CPU 111 increases the image Vcont if the density of the toner patch is lower than the predetermined density. The toner charge amount is in a reduced state immediately after the power source of the image forming apparatus is turned on. Therefore, the CPU 111 performs control for reducing the image Vcont. In the present exemplary embodiment, the image Vcont is controlled through the potential control for the calibration.

The CPU 111 can set the image Vcont to be obtained through the calibration by controlling the charging bias or the developing bias. The printer unit B performs image forming processing based on the image Vcont having been set until a new image Vcont is set in the next calibration.

When the calibration is performed, the image forming apparatus can stabilize the density of an output image. However, the calibration may not be frequently performed because the image forming apparatus does not execute the calibration unless a user instructs it. To stabilize the image density, it is recommendable to perform the calibration at appropriate timing. In particular, when the power source of the image forming apparatus is turned on again, the image forming apparatus may have unstable characteristics (i.e., characteristics different from those obtained before the power source is turned off). Therefore, it is desired to perform the calibration immediately after the power source of the image forming apparatus is turned on.

In the above-described automatic density control, the image forming apparatus forms a gradational pattern image on the photosensitive drum or on the intermediate transfer member. The sensor disposed in the vicinity of the photosensitive drum reads the density of the pattern image. The CPU 111 detects the density of the image pattern based on a reading result of the sensor and performs potential control and gradation control that are required to form an image.

The above-described image control is, for example, discussed in more detail in Japanese Patent Application Laid-Open No. 2003-202711.

The following problem may arise if the image density control is performed immediately after the power source is turned on, in a case where the image forming apparatus performs the above-described calibration.

If the image forming apparatus performs the calibration immediately after the power source of the image forming apparatus is turned on, the quality of output images formed after the calibration tends to be gradually deteriorated.

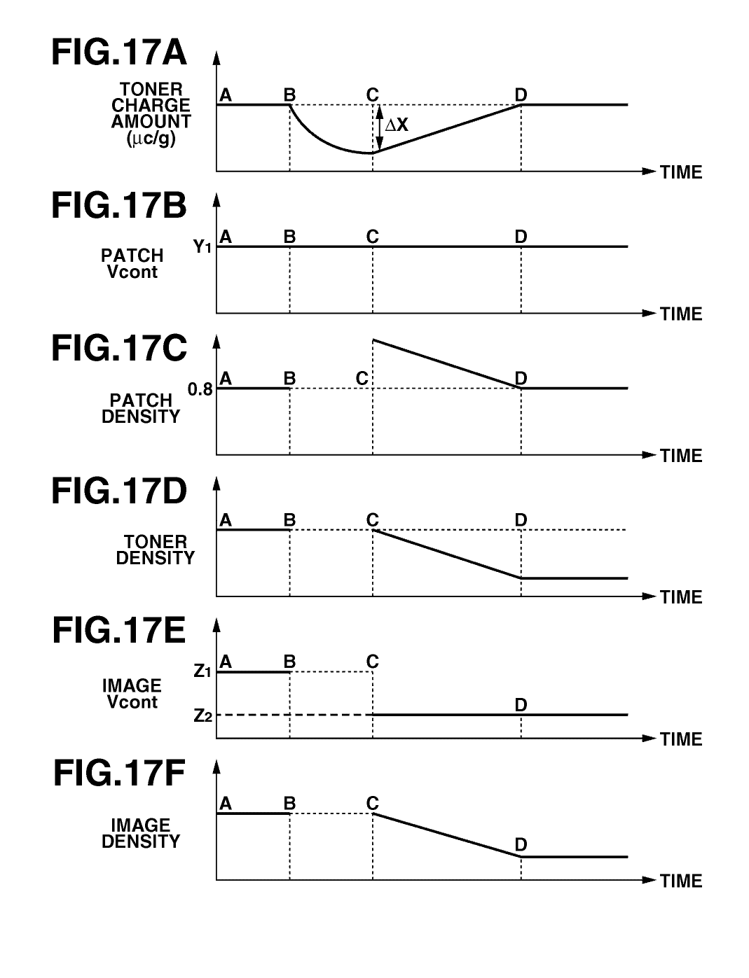

FIG. 17A illustrates a temporal change in the toner charge amount. FIG. 17B illustrates a temporal change in patch Vcont for forming a toner patch. FIG. 17C illustrates a temporal change in patch density. FIG. 17D illustrates a temporal change in toner density of the developing unit. FIG. 17E illustrates a temporal change in image Vcont. FIG. 17F illustrates a temporal change in image density of an image output from the image forming apparatus.

In the present exemplary embodiment, it is assumed that values in the period from point A to point B illustrated in FIGS. 17A to 17F are ideal values of the toner charge amount, patch Vcont, patch density, toner density, image Vcont, and image density. In FIGS. 17A to 17D, the power source of the image forming apparatus is in an ON state between point A and point B and after point C. On the other hand, the power source of the image forming apparatus is in an OFF state between point B and point C.

The developing unit does not operate in the power-off state or in the standby state, during which the toner particles are not stirred in the developing unit. Therefore, as illustrated in FIG. 17A, the toner charge amount decreases continuously in the power-off period between point B and point C.

Then, at the time when the power source is again turned on (i.e., point C), the toner charge amount is in a greatly reduced state (i.e., a reduction of ΔX (μC/g)) compared to the desired value. Even after the developing unit starts stirring the toner particles, the toner charge amount cannot be immediately restored to the original level. Therefore, the image density has a higher value after the power source is turned on.

If the image forming apparatus performs the above-described calibration in the above-described state (point C), the image forming apparatus forms an image pattern with toner particles having a reduced charge amount based on the predetermined stored image Vcont. Therefore, the density in respective gradations of an image pattern formed on a recording medium becomes higher than the predetermined density. For example, an image pattern corresponding to the density level 1.0 may have a density equivalent to level 1.1 if it is actually formed. An image pattern corresponding to the density level 0.5 may have a density equivalent to level 0.6 if it is actually formed.

On the other hand, in the above-described calibration, the image forming apparatus according to the present exemplary embodiment performs control for reducing the image Vcont so as to prevent the image pattern of the density level 1.0 from being formed as an image having the level 1.1 (see FIG. 17E). Therefore, the present exemplary embodiment can suppress an output image from becoming unstable in a state where the calibration is performed.

However, if the printer unit B continuously performs the image forming processing based on the image Vcont, the toner charge amount restores a predetermined value with elapsing time (see point D). On the other hand, as illustrated in FIG. 17F, the output image density decreases when the toner charge amount increases. It is desired to perform the calibration in an increasing stage of the toner charge amount. However, a relatively long time is required to execute the calibration. The image forming apparatus is forcibly stopped until the calibration is completed.

The image forming apparatus according to the present exemplary embodiment can prevent a change in output image density that may be caused if the calibration is performed immediately after the power source is turned on. Further, the image forming apparatus according to the present exemplary embodiment can stably supply toner particles into the developing unit 4. Moreover, the image forming apparatus according to the present exemplary embodiment can maintain the toner density while the toner particles are stably supplied into the developing unit 4.

The image forming apparatus according to the present exemplary embodiment can output an image whose density is stable even immediately after the power source of the image forming apparatus is turned on.

In the present exemplary embodiment, members similar to those described in the first exemplary embodiment are denoted by the same reference numerals and their descriptions are not repeated.

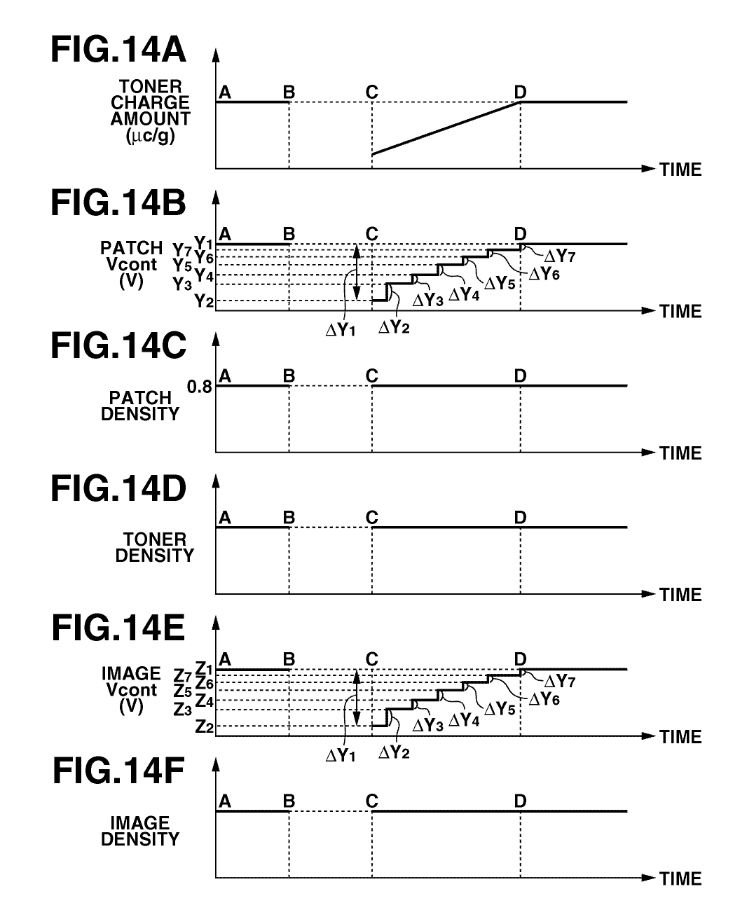

The image forming apparatus according to the present exemplary embodiment is described below with reference to FIG. 14. The image forming apparatus performs the calibration at the timing indicated by point C illustrated in FIGS. 14A to 14F. As illustrated in FIG. 14E, when the calibration is performed immediately after the power source is turned on, the CPU 111 performs control for reducing the image Vcont from first image Vcont to second image Vcont by an amount of ΔY1 (V). Meanwhile, as illustrated in FIG. 14B, the CPU 111 reduces the patch Vcont, which is required to form the toner patch Q, from first patch Vcont to second patch Vcont by an amount ΔY1 (V).

After the CPU 111 controls the image Vcont and the patch Vcont, the printer unit B forms the toner patch Q between images every formation of a predetermined number of images. The CPU 111 controls the patch Vcont based on the density of the toner patch Q, as described in the first exemplary embodiment. In the present exemplary embodiment, in addition to the control of the patch Vcont, the CPU 111 further controls the image Vcont based on a control amount ΔYn (V) of the patch Vcont.

For example, as illustrated in FIG. 14B, if it is determined that the density of the toner patch Q is lower than the predetermined density, the CPU 111 increases the patch Vcont from Y2 (V) (i.e., second patch Vcont) to Y3 (V) (i.e., third patch Vcont) by the amount ΔY2 (V). At the same time, the CPU 111 increases the image Vcont from Z2 (V) (i.e., second image Vcont) to Z3 (V) (i.e., third image Vcont) by the amount ΔY2 (V). If it is determined that the density of the toner patch Q is higher than the predetermined density, the CPU 111 performs control for reducing the control amount ΔYn (V).

Moreover, in the present exemplary embodiment, the control amount ΔYn (V) for the patch Vcont is equal to the control amount ΔYn (V) for the image Vcont. However, the control amount for the patch Vcont can be differentiated from the control amount for the image Vcont. In this case, the CPU 111 uses the control amount ΔYn (V) exclusively for the patch Vcont. The CPU 111 newly calculates a control amount ΔZn (V) for the image Vcont referring to the control amount ΔYn (V) as well as a predetermined function representing a correlative relationship between the patch Vcont and the image Vcont that can be stored beforehand.

In the present exemplary embodiment, the CPU 111 may also correct the γ correction circuit 209 in the following manner. More specifically, if the toner patch density is different from the predetermined density, the CPU 111 controls the γ correction circuit 209 to equalize the density gradation of an output image with the density gradation of an input image. In other words, the CPU 111 can newly generate a gradation correction table (LUT) for the γ correction circuit 209 or can modify the gradation correction table (LUT) based on information acquired from the density of the toner patch Q so that desired gradation characteristics can be obtained.

As described above, the gradation correction table (LUT) of the γ correction circuit 209 defines a rule in the correction of the output image density. The gradation correction table (LUT) regulates the relationship between an input signal level and an output signal level. The printer control unit 109 corrects an input image signal referring to the gradation correction table (LUT), so that an output image having ideal linear gradation characteristics can be obtained. Then, the printer control unit 109 generates a density level signal of an image information signal for each image.

The CPU 111 generates a new gradation correction table (LUT) that can be used to correct a deviation of an actually measured density gradation characteristics of the toner patch Q from ideal density gradation characteristics (e.g., linear characteristics). Alternatively, the CPU 111 can correct the gradation correction table (LUT). Thus, when the printer control unit 109 uses the newly generated or modified gradation correction table (LUT), the generated density level signal of the image information signal can reflect the present developing characteristics.

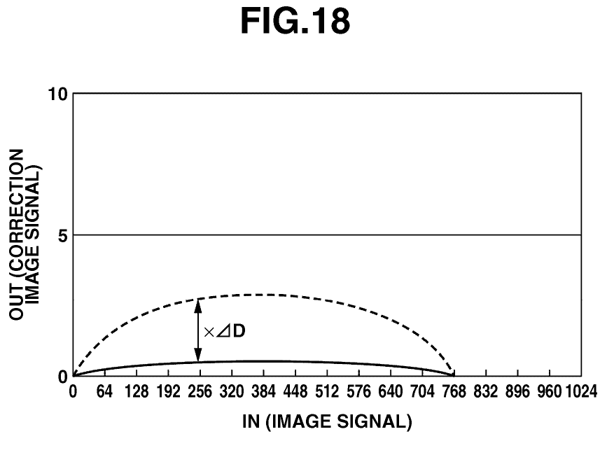

FIG. 18 is a graph illustrating an example correction table that can be used to correct the γ correction circuit 209. In FIG. 18, the solid line indicates a reference correction table. More specifically, the CPU 111 causes the density sensor 12 to detect the density of a toner patch Q in a density area different from that of the toner patch Q used in the control of the development contrast voltage described in the first exemplary embodiment. Then, based on a detection result ΔD, the CPU 111 generates a correction table indicated by the dotted line illustrated in FIG. 18 as a correction table ×ΔD. Then, the CPU 111 corrects an image signal based on the generated correction table. Through the above-described control, stability of the image density can be assured in every density area.

For example, the CPU 111 can generate the gradation correction table (LUT) in the following manner. The CPU 111 causes the printer unit B to form a plurality of toner patches Q corresponding to a plurality of density levels based on reference data including at least one density level different from the density level of the toner patch Q used in the development contrast voltage control described in the first exemplary embodiment.

Further, the CPU 111 causes the density sensor 12 to measure the density of reference images. Then, the CPU 111 compares a measurement result of each reference image with a standard density of each density level of the reference image. The CPU 111 generates a gradation correction table (LUT) based on the comparison result, so that the density of an output image is ideally in a linear relationship with the density level of image data not subjected to the density correction.

More specifically, the CPU 111 generates a correction table that can be used to correct a deviation of an actually measured density gradation characteristics of a density correction image from ideal density gradation characteristics (e.g., linear characteristics). The CPU 111 uses the generated gradation correction table (LUT) until the gradation correction table (LUT) is newly generated or modified.

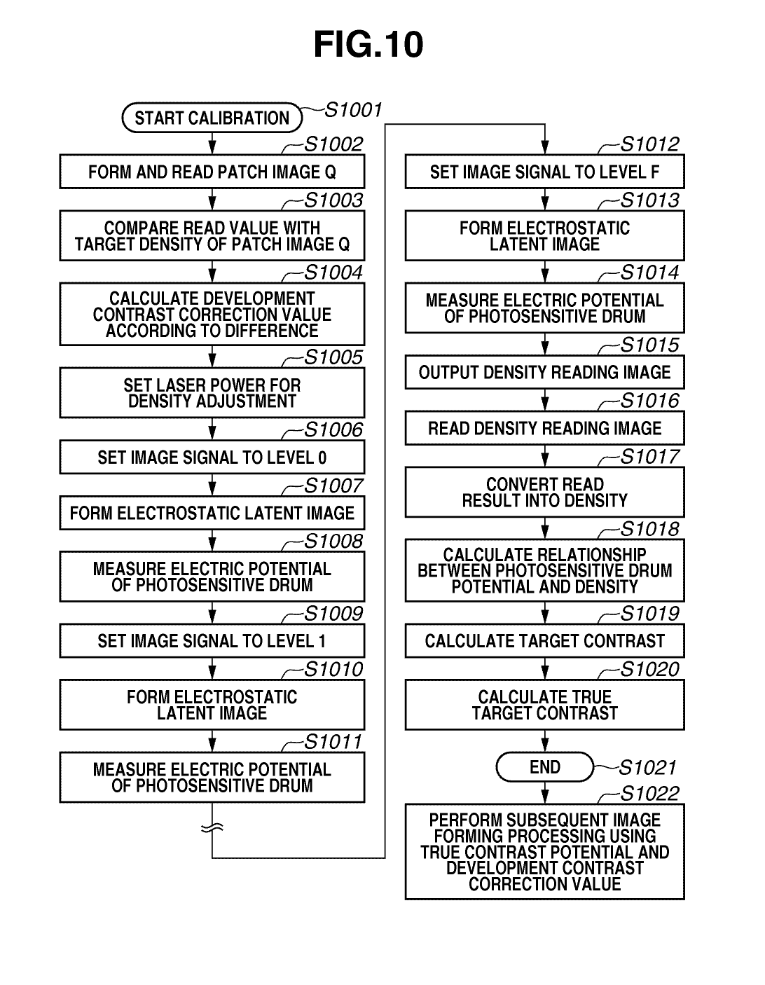

The above-described calibration is described in more detail with reference to FIGS. 10 to 13. A user can instruct the image forming apparatus to perform the calibration. An object to perform the calibration is to set the image Vcont required to realize the maximum image density. Another object is to maintain image gradation characteristics. In the present exemplary embodiment, the CPU 111 sets the image Vcont corresponding to the maximum image density (1.6) by controlling the laser power in an image area.

An example control that can be performed in the calibration by the CPU 111 of the printer unit B is described below with reference to FIG. 10. In step S1001, the CPU 111 starts calibration processing according to a calibration execution instruction entered via the operation unit 20 of the image forming apparatus.

In steps S1002 to S1004 of the calibration processing, the CPU 111 obtains a development contrast correction value to be used to correct the image Vcont that determines the maximum image density. More specifically, in step S1002, the CPU 111 controls the pattern generator 192 to form the toner patch Q having a predetermined density (i.e., the target density) on the photosensitive drum 1. Then, the CPU 111 causes the density sensor 12 to read the toner patch Q.

As illustrated in FIG. 6, the density sensor 12 outputs a density signal converted from the read data. The A/D conversion circuit 15 converts the input density signal (i.e., analog data) into digital data. The density conversion circuit 16 converts the digital data received from the A/D conversion circuit 15 into density data based on the density conversion table 16a. The CPU 111 receives the converted density data from the density conversion circuit 16.

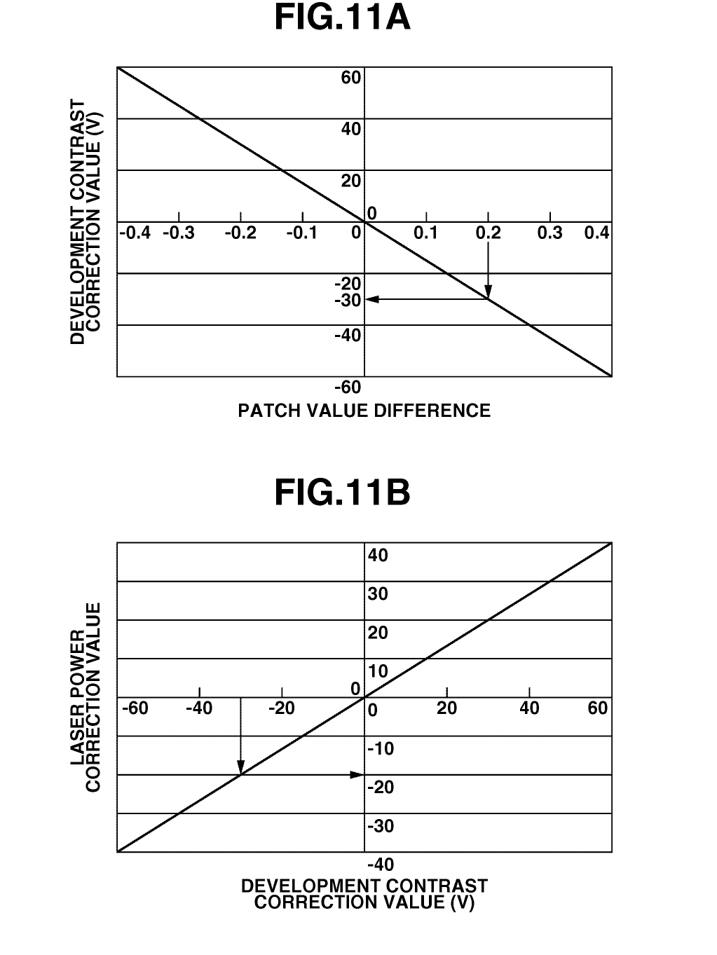

In step S1003, the CPU 111 compares the value read in step S1002 with the target density of the toner patch R. In step S1004, the CPU 111 calculates a development contrast correction value based on the comparison result. If the target density of the toner patch is 0.6 and the density read in step S1002 is 0.8, the comparison result in step S1003 becomes 0.2. In step S1004, the CPU 111 obtains −30 as the development contrast correction value based on the comparison result (i.e., 0.2) referring to a predetermined development contrast correction table illustrated FIG. 11A.

In the present exemplary embodiment, the CPU 111 controls the laser power to correct the image Vcont. Therefore, it is necessary to convert the development contrast correction value into a corresponding laser power correction value. Hence, the CPU 111 controls laser power based on a conversion table illustrated in FIG. 11B, which can be stored beforehand in ROM 113, which defines the relationship between the development contrast correction value and the laser power correction value. In the present exemplary embodiment, the CPU 111 obtains −20 as the laser power correction value corresponding to the development contrast correction value (i.e., −30).

The image Vcont can be also controlled based on the developing bias or the primary charge bias. A conversion table defining the relationship between the development contrast correction value and a developing bias correction value or a primary charge bias correction value can be stored in the ROM 113.

In step S1005, the CPU 111 sets a laser power level for the calibration, which is higher than the laser power level in the ordinary image forming processing. The reason why the laser power is set higher for the calibration is to surely obtain the target density (i.e., the maximum image density (=1.6)) in an image being calibrated. In the present exemplary embodiment, the CPU 111 increases the laser power level so that the image Vcont becomes 100 V higher than the ordinary value.

Next, the CPU 111 executes processing for calculating the image Vcont. More specifically, in steps S1005 to S1014, the CPU 111 obtain a relationship between an image signal for forming a pattern image having a predetermined density and the potential of an electrostatic latent image formed on the photosensitive drum 1 according to the image signal.

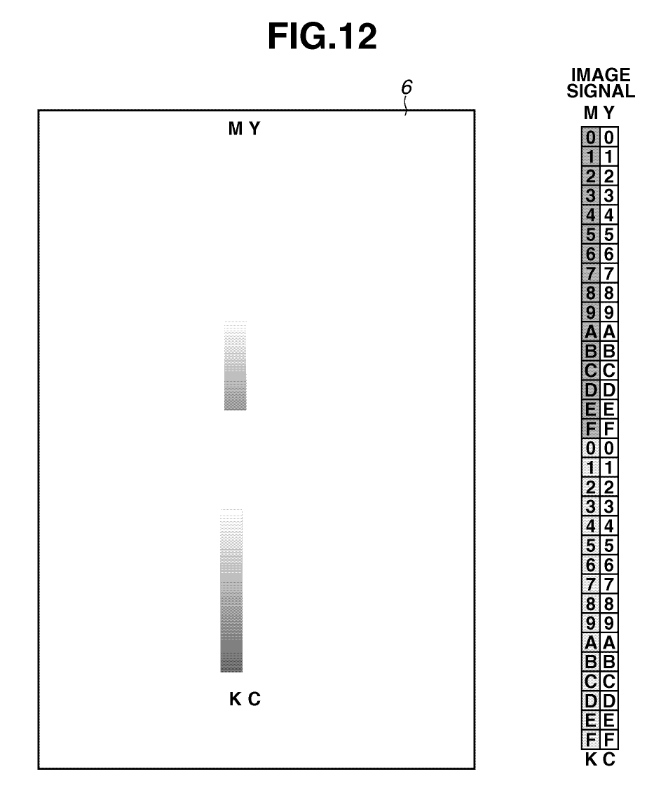

Further, in steps S1015 to S1017, the CPU 111 obtains a relationship between the above-described image signal and the density of the image formed according to the image signal. Then, referring to the above-described relationships, in step S1018, the CPU 111 calculates a relationship between the potential of the electrostatic latent image and the image density illustrated in FIG. 12. In step S1019, the CPU 111 calculates the image Vcont.

The control processing to be performed in steps S1005 to S1022 is described below in more detail. First, in step S1006, the CPU 111 sets an image signal of 600 dpi to level 0. In step S1007, the CPU 111 causes the printer unit B to form an electrostatic latent image on the photosensitive drum 1. In step S1008, the CPU 111 measures the electric potential of the photosensitive drum 1 with a potential sensor 5 disposed in the confronting relationship with photosensitive drum 1. In step S1009, the CPU 111 sets the image signal to level 1. In step S1010, the CPU 111 forms an electrostatic latent image on the photosensitive drum 1. In step S1011, the CPU 111 causes the potential sensor 5 to measure the potential of the photosensitive drum 1.

In this manner, in steps S1007 to S1014, the CPU 111 causes the printer unit B to sequentially form electrostatic latent images of level 1 to level F and causes the potential sensor 5 to read the potential of each image. The CPU 111 obtain a relationship between the image signal and the potential of the electrostatic latent image based on the measured potentials of the electrostatic latent images corresponding to respective image signals that are read in steps S1005 to S1014.

Then, in step S1015, the CPU 111 causes the developing unit 4 to visualize the above-described electrostatic latent images with the toner to form pattern images illustrated in FIG. 12 on the recording material P. The pattern image on the right side of FIG. 12 indicates density information of the image pattern formed on the recording material P, according to which the level 0 is lowest and the level F is highest in the density. Intermediate density levels 1 to E are ranging between the level 0 and the level F.

In step S1016, the CPU 111 causes the reader unit A to read the output image as the document 101. In step S1017, the CPU 111 detects the image density based on the read result. In this case, the CPU 111 obtains a relationship between the image signal and the image density based on the detection result.

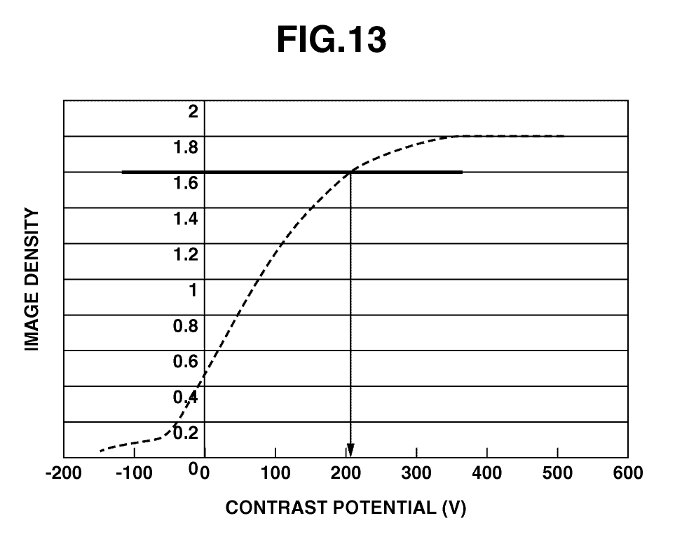

Then, the CPU 111 calculates a relationship between the potential of the electrostatic latent image and the image density as illustrated in FIG. 13, referring to the relationship between the image signal and the potential of the electrostatic latent image as well as the relationship between the image signal and the image density.

FIG. 13 illustrates an example relationship between the image density and the image Vcont corresponding to the image density. In step S1018, the CPU 111 calculates a relationship between the potential corresponding to the image density of the photosensitive drum 1 and the image density.

In step S1019, the CPU 111 calculates an optimum value of the image Vcont that can equalize the density of the image pattern with the target density. In step S1020, the CPU 111 calculates a true target image Vcont to be used in the image forming processing following the calibration based on the optimum image Vcont (i.e., a provisional target image Vcont) and the above-described development contrast correction value. With the true target image Vcont, the desired density (i.e., 1.6) can be obtained. In step S1021, the CPU 111 terminates the control. In step S1022, the CPU 111 uses the true image Vcont obtained in step S1020 for the subsequent image forming processing.

In the image forming apparatus of the present exemplary embodiment, the CPU 111 controls the patch Vcont by an amount comparable with a difference between a pre-control value and a post-control value of the image Vcont controlled through the above-described calibration. The CPU 111 further performs control for increasing/decreasing the image Vcont by an amount comparable with a difference between a pre-control value and a post-control value of the patch Vcont controlled based on the density of the toner patch Q.

In the present exemplary embodiment, similar to the first exemplary embodiment, the CPU 111 changes the laser power to control the patch Vcont and the image Vcont.

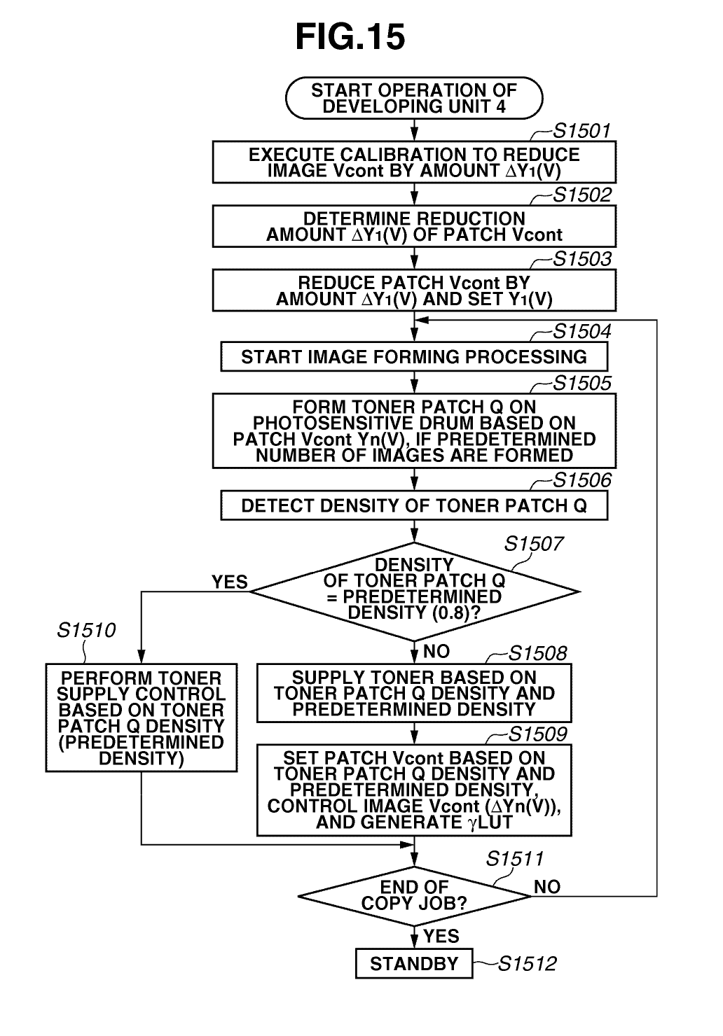

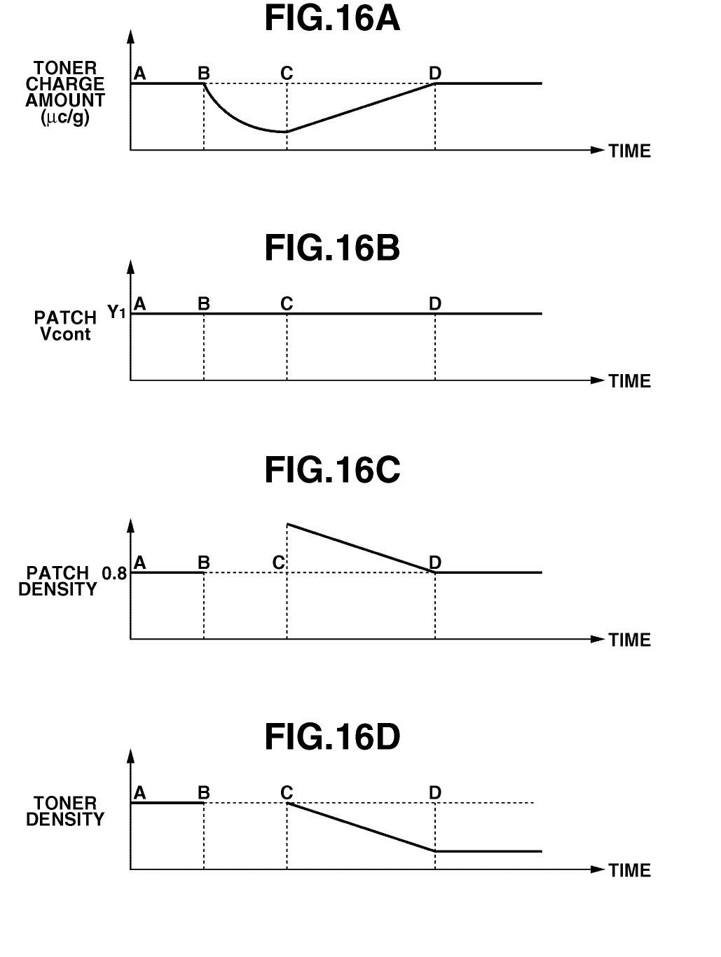

FIG. 15 is a flowchart illustrating example control that can be executed by the CPU 111 according to the present exemplary embodiment.

In step S1501, the CPU 111 allows a user to perform the above-described calibration using a test pattern formed on the recording material P after the power source of the image forming apparatus 100 is turned on. The CPU 111 calculates the toner reduction charge amount X (μC/g) based on the test pattern density and reduces the image Vcont by the amount ΔY1 (V) based on the calculated amount X (μC/g). Therefore, the image Vcont changes from first image Vcont Z1 to second image Vcont Z2.

In step S1502, the CPU 111 sets the control amount of the patch Vcont to ΔY1 (V) based on the control amount ΔY1 (V) of the image Vcont. In step S1503, the CPU 111 reduces the patch Vcont by the amount ΔY1 (V). Therefore, the patch Vcont changes from first patch Vcont Y1 to second patch Vcont Y2. It is believed that the toner patch Q formed by the patch Vcont Y2 has the predetermined density (i.e., 0.8).

In step S1504, the CPU 111 causes the printer unit B to start image forming processing before the toner charge amount restores its ideal value. If image formation of a predetermined number of recording media is completed, then in step S1505, the CPU 111 causes the printer unit B to form a toner patch Q on the photosensitive drum 1 based on the patch Vcont Y2.

In step S1506, the CPU 111 causes the density sensor 12 to detect reflection light from the toner patch Q and calculates the density of the toner patch Q based on the detection result. In step S1507, the CPU 111 determines whether the calculated density of the toner patch Q is equal to the predetermined density (i.e., 0.8). If it is determined that the density of the toner patch Q is different from the predetermined density (NO in step S1507), then in step S1508, the CPU 111 controls the amount of toner supplied from the toner replenishment tank 33 into the developing unit 4 based on the density of the toner patch Q and the predetermined density.

In step S1509, the CPU 111 controls the laser power of the semiconductor laser to adjust the patch Vcont Yn so as to equalize the density of the toner patch Q with the predetermined density (i.e., 0.8). Further, instep S1509, the CPU 111 newly generates the γLUT based on the toner patch Q and the predetermined density. The control amount in this case is equal to the above-described ΔYn (V). The CPU 111 increases the image Vcont by the amount ΔYn (V). Accordingly, the density of an image to be formed based on the image Vcont increases by a restoration amount of the toner charge amount.

If it is determined that the density of the toner patch Q is within a predetermined density range (YES in step S1507), then in step S1510, the CPU 111 supplies toner particles from the toner replenishment tank 33 to the developing unit 4 based on the density of the toner patch Q (i.e., the predetermined density). In this case, the CPU 111 does not control the patch Vcont and the image Vcont.

After step S1509 or step S1510, the processing proceeds to step S1511, in which the CPU 111 determines whether the copy job has been completed. If it is determined that the copy job has been completed (YES in step S1511), then in step S1512, the CPU 111 brings the image forming apparatus 100 into the standby state. If it is determined that the copy job is not yet completed (NO in step S1511), the processing returns to step S1504. The CPU 111 causes the printer unit B to start image forming processing.

In the present exemplary embodiment, the control value ΔY1 (V) for the patch Vcont based on the control value of the image Vcont is equal to the control value ΔY1 (V) for the control value of the image Vcont. Further, the control value ΔYn (V) for the image Vcont based on the control value of the patch Vcont is equal to the control value ΔYn (V) for the patch Vcont. However, the development contrast of each image forming apparatus may be variable depending on potential attenuation characteristics or developing characteristics of the photosensitive drum 1.

Therefore, it is not always desired to equalize the change amount of the image Vcont with the change amount of the patch Vcont. In such a case, considering the potential attenuation characteristics or developing characteristics of the photosensitive drum 1, the CPU 111 sets the control value for the patch Vcont based on the image Vcont and the control value for the image Vcont based on the control value of the patch Vcont.

Through the above-described control, the post-control development contrast can be controlled according to a variation in the toner charge amount even when the development contrast control is performed in a state where the toner charge amount is reduced. The output image density can be stabilized.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2008-235010 filed Sep. 12, 2008, which is hereby incorporated by reference herein in its entirety.

What is claimed is:

1. An image forming apparatus, comprising:
an image carrier;
an exposure unit configured to form an electrostatic latent image on the image carrier;
a developing unit including a toner containing unit configured to accommodate a predetermined amount of toner, a toner supply unit configured to supply replenishment toner into the toner containing unit, a stirring unit configured to stir the toner to impart electric charge to the toner, a toner carrying member configured to carry the toner charged by the stirring unit, and a bias applying unit configured to apply a developing bias to the toner carrying member to develop the electrostatic latent image formed on the image carrier with the toner carried by the toner carrying member so as to have a density according to a potential difference between the developing bias and the electrostatic latent image;
a density sensor configured to detect a density of a toner pattern developed by the developing unit; and
a control unit configured to control an amount of the toner supplied to the toner containing unit by the toner supply unit based on the density of the toner pattern detected by the density sensor,
wherein the control unit changes the potential difference so that a toner pattern having a predetermined density can be formed when the stirring unit starts stirring the toner.

2. The image forming apparatus according to claim 1, wherein the control unit changes the potential difference by controlling the bias applying unit so that the toner pattern having the predetermined density can be formed if a state where the stirring unit does not impart electric charge to the toner continues for a predetermined time.

3. The image forming apparatus according to claim 1, wherein the control unit maintains the amount of the toner supplied to the toner containing unit in a case where the density sensor detects that the density of the toner pattern is the predetermined density, and the control unit reduces the amount of the toner supplied to the toner containing unit based on the density of the toner pattern and the predetermined density in a case where the density of the toner pattern is higher than the predetermined density, and further the control unit increases the amount of the toner supplied to the toner containing unit based on the density of the toner pattern and the predetermined density in a case where the density of the toner pattern is lower than the predetermined density.

4. The image forming apparatus according to claim 1, wherein the exposure unit is a laser beam source and the control unit increases the potential difference by increasing a quantity of light emitted from the laser beam source to the image carrier and reduces the potential difference by decreasing the light quantity.

5. The image forming apparatus according to claim 1, wherein the control unit increases the potential difference by increasing the developing bias applied to the bias applying unit and reduces the potential difference by decreasing the developing bias.

6. The image forming apparatus according to claim 2, wherein the state where the stirring unit does not impart electric charge to the toner is a state where a power source of the image forming apparatus is turned off.

7. The image forming apparatus according to claim 2, wherein the state where the stirring unit does not impart electric charge to the toner is a state where a power source of the image forming apparatus is turned on and the image forming apparatus is in a standby condition.

8. The image forming apparatus according to claim 1, wherein the toner containing unit accommodates a developer including toner particles and carrier particles, and the stirring unit stirs the developer to impart electric charge to the toner.

9. The image forming apparatus according to claim 1, wherein if the number of times that the density of the toner pattern detected by the density sensor is equal to the desired density exceeds a predetermined value, the control unit sets the potential difference as a constant value.

10. The image forming apparatus according to claim 1, wherein the control unit forms the toner pattern between images every time image formation of a predetermined number of recording media is completed.
